(19) United States
(12) Patent Application Publication
(10) Pub. No.: US 2006/0249245 A1
(43) Pub. Date: Nov. 9, 2006

(54) Ceramic and glass correction inks

(76) Inventors: Bernard Balling, Lockport, NY (US); Pamela A. Geddes, Alden, NY (US); Daniel J. Harrison, Pittsford, NY (US); Claire A. Jalbert, Buffalo, NY (US); Jennifer L. Eskra, Lockport, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 11/481,464

(22) Filed: Jul. 6, 2006

Related U.S. Application Data
(63) Continuation-in-part of application No. 11/071,015, filed on Mar. 3, 2005.
(63) Continuation-in-part of application No. 11/072,028, filed on Mar. 4, 2005.
(63) Continuation-in-part of application No. 11/074,155, filed on Mar. 7, 2005.
Application No. 11/074,155 is a continuation of application No. 10/621,976, filed on Jul. 17, 2003, now Pat. No. 6,990,904.
Application No. 10/621,976 is a continuation-in-part of application No. 10/265,013, filed on Oct. 4, 2002, now Pat. No. 6,766,734.
Application No. 10/265,013 is a continuation-in-part of application No. 10/080,783, filed on Feb. 22, 2002, now Pat. No. 6,722,271.
Application No. 10/080,783 is a continuation-in-part of application No. 09/961,493, filed on Sep. 22, 2001, now Pat. No. 6,629,792.
Application No. 09/961,493 is a continuation-in-part of application No. 09/702,415, filed on Oct. 31, 2000, now Pat. No. 6,481,353.
(60) Provisional application No. 60/702,067, filed on Jul. 22, 2005.

(51) Int. Cl. B44C 1/17

(52) U.S. Cl. 156/241

(57) ABSTRACT

Disclosed in this specification is a ceramic correction fluid and methods for applying the same. The ceramic correction fluid is suitable for patching imaged substrates, including both glass and ceramic substrates, such that voids in the image are corrected.

### CROSS-REFERENCE TO RELATED PATENT APPLICATIONS

This application claims the benefit of the filing date of U.S. provisional patent application 60/702,067 (filed on Jul. 22, 2005). This application is also a continuation-in-part of co-pending patent application U.S. Ser. No. 11/071,015 (filed Mar. 3, 2005); Ser. No. 11/072,028 (filed Mar. 4, 2005); Ser. No. 11/074,155 (filed Mar. 7, 2005); each of which are continuation applications of co-pending U.S. Ser. No. 10/621,976 (filed on Jul. 17, 2003); which is a continuation-in-part of U.S. Ser. No. 10/265,013 (filed on Oct. 4, 2002); now U.S. Pat. No. 6,766,734 (issued Jul. 27, 2004); which in turn is a continuation-in-part of U.S. Ser. No. 10/080,783 (filed on Feb. 22, 2002); now U.S. Pat. No. 6,722,271 (issued on Apr. 20, 2004); which in turn is a continuation-in-part of co-pending U.S. Ser. No. 09/961,493 (filed on Sep. 22, 2001), now U.S. Pat. No. 6,629,792 (issued Oct. 7, 2003); which in turn is a continuation-in-part of U.S. Ser. No. 09/702,415 (filed on Oct. 31, 2000); now U.S. Pat. No. 6,481,353 (issued on Nov. 19, 2002). The entire disclosure of each of these patents and patent applications is hereby incorporated by reference into this specification.

### FIELD OF THE INVENTION

In one embodiment, this invention pertains to a ceramic correction fluid for writing on a ceramic substrate that, after curing under ambient conditions and drying, is resistant to degradation by ammonium hydroxide and/or isopropyl alcohol.

### BACKGROUND OF THE INVENTION

Published United States patent application 2004/0050279A1 to Ibarra (Thermal transfer assembly for ceramic imaging), the entire disclosure of which is hereby incorporated by reference into this specification, describes and claims a ceramic substrate onto which a durable digital image has been affixed. In claim 140 of this published patent application, there is described: “The product of the process of subjecting a digitally printed assembly to a temperature of at least 500 degrees Centigrade for at least 6 minutes to produce a heat treated assembly, wherein said digitally printed assembly comprises a substrate and, disposed on said substrate, a digitally printed ceramic ink image, wherein said ceramic ink image comprises from about 15 to about 94.5 weight percent of a solid, volatilizable carbonaceous binder, from about 5 to about 75 weight percent of a film-forming frit, and at least 0.5 weight percent of a metal-oxide containing ceramic colorant, and wherein: (a) said solid, volatilizable carbonaceous binder, after it has been heated at a temperature greater than 500 degrees Centigrade for at least 6 minutes in an atmosphere containing at least about 15 volume percent of oxygen, is substantially volatilized such that less than about 5 weight percent of said volatilizable carbonaceous binder remains as a solid phase, (b) said film-forming frit has a melting temperature of greater than about 300 degrees Centigrade, (c) said metal oxide containing ceramic colorant has a particle size distribution such that substantially all of its particles are smaller than about 20 microns and is selected from the group consisting of opacifying material, ceramic pigment material, and mixtures thereof, (d) said metal oxide containing ceramic colorant material has a first refractive index, and said film-forming frit has a second refractive index, such that the difference between such first refractive index and said second refractive index is at least about 0.1, (e) said metal oxide containing ceramic colorant material has a first melting point, and said film-forming frit has a second melting point, such that said first melting point exceeds said second melting point by at least about 50 degrees, and (f) said metal oxide containing material has a first concentration in said ceramic ink layer, said film forming glass frit has a second concentration in said ceramic ink layer, such that the ratio of said first concentration to said second concentration is no greater than about 1.25.″ This is an example of one type of an imaged ceramic product which may require correction during or after production. Other processes known to those skilled in the art (screen printing, acid etching, etc.) may also result in ceramic or glass articles bearing images that could require correction. Further reference may be had to U.S. Pat. No. 6,694,885 to Geddes (Thermal transfer system for fired ceramic decals), the content of which is hereby incorporated by reference into this specification.

Any image may have minor defects that could benefit from a correction step separate from the original image creation step.

It is an object of this invention to provide a ceramic correction fluid that is capable of “patching” such minor defects and that, if applied to the “fired image,” will cure under ambient conditions to a durable, optically compatible coating.

### SUMMARY OF THE INVENTION

In accordance with this invention, there is provided a ceramic correction fluid that, after curing under ambient conditions, produces a coating that is resistant to degradation by isopropyl alcohol and is also resistant to degradation by glass cleaners and solutions containing ammonium hydroxide. There is also provided a process for the usage of such a correction ink.

### BRIEF DESCRIPTION OF THE DRAWINGS

The invention will be described by reference to the following drawings, in which like numerals refer to like elements, and in which:

FIG. 1 is a schematic of a fired product produced in accordance with the process of U.S. patent application Ser. No. 10/621,976;

FIG. 2 is a schematic of the fired product of FIG. 1 to which the ceramic correction fluid of this invention has been applied;

FIG. 3 is a flow diagram of a preferred process for making the product of FIGS. 1 and 2;

FIG. 4 is an illustration of one ink applicator of the present invention;

FIG. 5 is a depiction of another ink applicator of the present invention; and

FIG. 6 is a flow diagram of the process for using a ceramic correction fluid.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements.

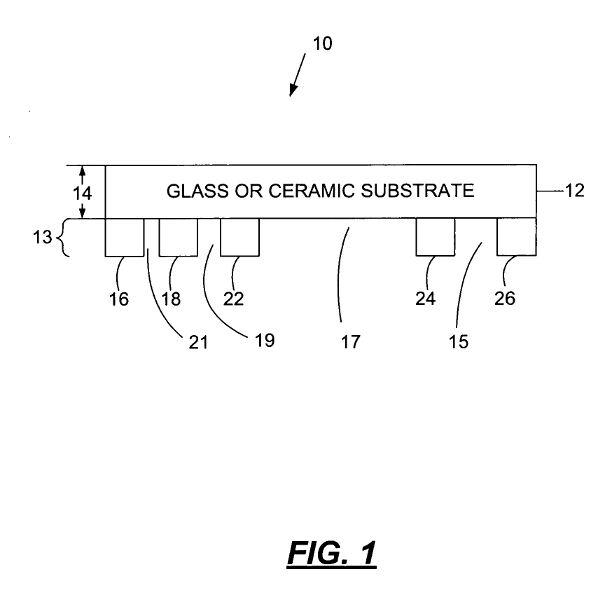

FIG. 1 is a schematic illustration of a fired substrate that is similar to the fired substrate 478 depicted in FIG. 32 of United States published patent application 2004/0050279A1 to Ibarra (Thermal transfer assembly for ceramic imaging). Referring to such FIG. 1, it will be seen that fired substrate assembly 10 is comprised of a substrate 12.

The process of this invention, and also of published United States patent application 2004/0050279A1 to Ibarra (Thermal transfer assembly for ceramic imaging), is applicable to both ceramic substrates (such as, e.g., substrates comprised of glass, porcelain, ceramic whitewares, metal oxides, clays, porcelain enamel coated substrates and the like) and non-ceramic substrates (such as, e.g., substrates comprised of polymers, thermoplastics, elastomers, thermosets, organic coatings, films, composites, sheets and the like). In one embodiment, the substrate used is a ceramic substrate.

As used herein, the term “ceramic” includes glass, conventional oxide ceramics, and non-oxide ceramics (such as carbides, nitrides, etc.). When the ceramic material is glass, and in one embodiment, such glass is preferably float glass made by the float process. See, e.g., pages 43 to 51 of “Commercial Glasses,” published by The American Ceramic Society, Inc. (of Columbus Ohio) in 1984 as “Advances in Ceramics, Volume 18.”

The ceramic substrate used in the process of this invention, in one embodiment, preferably is a material that is subjected to a temperature of at least about 550 degrees Celsius during processing and, in one aspect of this embodiment, comprises one or more metal oxides. Typical of such ceramic substrates are, e.g., glass, ceramic whitewares, enamels, porcelains, etc. Thus, by way of illustration and not limitation, one may use the process of this invention to transfer and fix color images onto ceramic substrates such as dinnerware, outdoor signage, glassware, imaged giftware, architectural tiles, architectural glass, window glass, color filter arrays, floor tiles, wall tiles, perfume bottles, wine bottles, beverage containers, and the like.

The substrate 12 may be “fabricated” or “finished.” See, e.g., FIG. 40 of published United States patent application 2004/0050279A1. As is disclosed at page 25 of such published patent application, “Referring again to FIG. 40, and in step 802 thereof, the substrate 903 is ‘fabricated’ or ‘finished.’ As is known to those skilled in the art, after the substrate 903 leaves the annealing lehr after being fabricated at the melting tank, it still may require one or more of a variety of secondary, or finishing operations, before the ware is complete. Thus, e.g., the substrate 803 may be cut to size, or subjected to grinding, or polished, or heat treated (such as, e.g., by tempering), or etched, or stained, or strengthened, or coated, etc.”

In one embodiment, the substrate 12 is a plastic film. In one aspect of this embodiment, substrate 12 is, e.g., one or more of the flexible substrate films disclosed in U.S. Pat. No. 5,665,472 to Tanaka (Thermal transfer sheet), the entire disclosure of which is hereby incorporated by reference into this specification. Thus, e.g., one may use plastic films such as polyester, polyethyleneterephthalate, polypropylene, polymethylmethacrylate, cellophane, polycarbonate, cellulose acetate, polyethylene, polyvinyl chloride, polystyrene, nylon, polyimide, polyvinylidene chloride, polyvinyl alcohol, fluororesin, chlorinated resin, ionomer, laminates and blends of these materials, and the like.

In one embodiment, the substrate 12 is a window film. As is known to those skilled in the art, window film is a plastic film that is adhesively or statically attached to a glass substrate. Reference may be had to U.S. Pat. No. 6,166,852 to Miro (Window film with optical brightener), the entire disclosure of which is hereby incorporated by reference into this specification. For other patents referring to window film, reference may be had to, e.g., U.S. Pat. No. 6,497,777 to Huang (Window film application process), U.S. Pat. No. 6,294,233 to Barth (Edge-sealed window films and methods), U.S. Pat. No. 6,090,451 also to Barth (Window film edge sealing method), U.S. Pat. No. 6,030,671 to Yang (Low emissivity window films), U.S. Pat. No. 5,992,107 to Poirier (Apparatus for edge mounting security window film in a window frame), U.S. Pat. No. 5,956,175 to Hojnowski (Solar controlled window film), U.S. Pat. No. 5,925,453 to Kase (Window film), U.S. Pat. Nos. 5,521,004 and 5,468,563 both to Reiners (Reflection-reduced, bondable stretched film as window film for envelopes), U.S. Pat. No. 5,421,939 to Scher (Prefabricated solar window film graphics and a method for manufacturing and applying the same), U.S. Pat. No. 4,797,317 to Oliver (Solar control window film), U.S. Pat. No. 4,590,124 to Schoenberg (Storm window film), U.S. Pat. No. 4,581,282 to Higgins (Enhanced durability solar insulating window film and assembly using the same), U.S. Pat. No. 4,565,719 to Phillips (Energy control window film systems and methods for manufacturing the same), U.S. Pat. No. 4,514,465 to Schoenberg (Storm window film comprising at least five layers), and the like. The entire disclosure of each of these United States patents is hereby incorporated by reference into this specification.

In one embodiment, the substrate 12 is a porcelain enamel substrate. As is known to those skilled in the art, porcelain enamel is a substantially vitreous inorganic coating bonded to metal by fusion at about 426 degrees Celsius; it is generally composed of various blends of low-sodium frit, clay, feldspar, and other silicates ground in a ball mill and sprayed onto a metal surface (steel, iron, or aluminum) to which it bonds firmly after firing, giving it a glass-like, fire-polished surface. Reference may be had, e.g., to U.S. Pat. No. 6,610,229 to Morales (Fiber perform process employing a porcelain enamel coating screen tool); U.S. Pat. No. 6,544,355 to Nishimura (Continuous casting steel plate for porcelain enameling excellent in formability resistance to occurrence of bubble or black point, and adhesion with porcelain enamel); U.S. Pat. No. 6,475,939 to Souchard (Porcelain enamel for aluminized steel); U.S. Pat. No. 6,177,201 to Wallace (Porcelain enamel coating for high-carbon steel); U.S. Pat. No. 6,004,894 to Faust (Reflective Porcelain enamel coating compositions); U.S. Pat. No. 5,998,037 to Sridharan (Porcelain enamel composition for electronic applications); U.S. Pat. No. 5,973,298 to Kaligren (Circular film heater and porcelain enamel cooktop); U.S. Pat. No. 5,779,919 to DiPietro (Porcelain enamel sign and method of manufacture); reissue 35,625 to Roberts (Process for making a chemically-resistant porcelain enamel); U.S. Pat. No. 5,512,521 to Fu (Cobalt-free, black, dual purpose porcelain enamel glass); U.S. Pat. No. 5,387,439 to Roberts (Process for making a chemically-resistant porcelain enamel); U.S. Pat. No. 5,382,552 to Saad (Rare earth-containing alkali silicate frits and their use for the preparation of porcelain enamel coatings with improved cleanability); U.S. Pat. No. 5,053,740 to Schultz (Porcelain enamel temperature sensor for heating ovens); U.S. Pat. No. 4,732,794 to Hyde (Porcelain enamel composition and substrates coated therewith); U.S. Pat. No. 4,361,654 to Ohmura (Porcelain enamel frit for sheet iron ground coat); U.S. Pat. No. 3,930,062 to Nedeljkovic (Composition and method for electrostatic deposition of dry porcelain enamel frit); U.S. Pat. No. 3,912,523 to Rion (Heat resistant porcelain enamel coatings containing vermiculite); and the like. The entire disclosure of each of these United States patents is hereby incorporated by reference into this specification.

Referring again to FIG. 1, and in one embodiment thereof, the substrate 12 is a silicon wafer.

In one embodiment, the substrate 12 is tempered glass. As is known to those skilled in the art, tempering is a process in which the hardness and strength of a substrate is increased by quenching or heat treatment. Reference may be had, e.g., to U.S. Pat. No. 3,734,706 to Ritter (Producing bent tempered glass sheets), U.S. Pat. No. 3,938,980 to French (Method and apparatus for forming tempered glass articles), U.S. Pat. No. 4,261,723 to Hargrave (Controlling kinking of tempered glass sheets), U.S. Pat. No. 4,406,918 to Saby (Tempered glass dielectric member for an electrical insulator, and an insulator using said member), U.S. Pat. No. 4,471,024 to Pargamin (Method of manufacturing a tempered glass dielectric material for use as an electrical insulator and insulator fabricated therefrom), U.S. Pat. No. 4,482,943 to Hogue (Tempered glass globe), U.S. Pat. No. 4,508,783 to Aubry (Method for the differentiated hardening of glass sheets, especially of automobile windshields, and tempered glass sheet), U.S. Pat. No. 4,826,522 to d'Iribarne (Method and apparatus for making contact-tempered glass sheets with reinforced edge stresses), U.S. Pat. No. 5,213,440 to Yeh (Method of making yellow transparent tempered glass and glass product), U.S. Pat. No. 5,484,637 to Paragon (Tempered glass artist palettes), U.S. Pat. No. 6,032,489 to Yoshizawa (Method for manufacturing tempered glass sheet and apparatus for manufacturing the same), U.S. Pat. No. 6,067,820 to Silander (Process for the heat-soak treatment of tempered glass panels), U.S. Pat. No. 6,079,227 to Yoshizawa (Method for manufacturing bent and tempered glass sheet and apparatus for manufacturing the same), U.S. Pat. No. 6,180,237 to Kato (Tempered glass), U.S. Pat. No. 6,257,228 to Braccini (Tempered glass hob for kitchen), U.S. Pat. No. 6,333,285 to Chopinet (Glass composition and chemically tempered glass substrate), U.S. Pat. No. 6,381,909 to Liao (Corner transom fitting for frameless tempered glass door), U.S. Pat. No. 6,401,490 to Yoshizawa (Method for manufacturing tempered glass sheet and apparatus for manufacturing the same), U.S. Pat. No. 6,422,673 to Bienick (Refrigerator compartment housing vertically adjustable shelves, each formed from a piece of tempered glass snapped-fastened to an injection molded frame); U.S. Pat. No. 6,555,202 to Shukuri (Tempered glass sheet for vehicle and vehicle window), U.S. Pat. No. 6,665,984 to Bienick (Washer door or lid defined by a tempered glass panel bordered by an open frame-like encapsulation of one-piece injection molded polymeric/copolymeric synthetic plastic material), and the like. The entire disclosure of each of these United States patents is hereby incorporated by reference into this specification.

In one embodiment, and referring again to FIG. 1, the substrate 12 is comprised of or consists essentially of reflective glass. As is known to those skilled in the art, reflective glass is an ordinary float glass with a metallic coating to reduce solar heat. This special metallic coating also produces a mirror effect, reducing the transparency of the glass. Reference may be had, e.g., to U.S. Pat. No. 3,619,038 to Underhill (Day/night prism rearview mirror), U.S. Pat. No. 4,104,102 to Eagon (Method of making a retroreflective laminate), U.S. Pat. No. 4,226,658 to Carlson (Method of making retroreflective laminate), U.S. Pat. No. 4,251,572 to Herliczek (Method of restoring or repairing reflective glass), U.S. Pat. No. 4,443,510 to Watt (Conformable removable reflective marking tape), U.S. Pat. No. 4,459,470 to Shlichta (Glass heating panels and method for preparing the same from architectural reflective glass), U.S. Pat. No. 4,546,042 to Quon (Product having combined phosphorescent-reflective appearance and method), U.S. Pat. No. 4,548,836 to Middleton (Method of making an infrared reflective glass sheet-II), U.S. Pat. No. 4,573,763 to Thomas (Three-dimensional flexible reflectors), U.S. Pat. No. 4,815,818 to Thomas (three-dimensional flexible reflectors), U.S. Pat. No. 4,991,851 to Melesio (Reflective golf ball and method), U.S. Pat. No. 5,039,200 to Michler (Reflective safety stick for walking and jogging), U.S. Pat. No. 6,232,603 to Nelson (Rain sensor operation on solar reflective glass), U.S. Pat. No. 6,291,074 to Sakai (Heat-radiation reflective glass), and the like. The entire disclosure of each of these United States patents is hereby incorporated by reference into this specification.

Referring again to FIG. 1, and in particular to fired substrate assembly 10, it will be seen that, in the embodiment depicted, the fired substrate assembly 10 is similar to the heat-treated assembly 475 depicted in FIG. 32 of published United States patent application 2004/0050279A1. With regard to such assembly 475, and as is disclosed at page 17 of such published patent application, ” . . . in the embodiment depicted, in areas 477, 479, 481, and 483, some or the entire image has been eroded during the heat treating. Without wishing to be bound to any particular theory, applicants believe that this erosion can occur when gases are formed during the heat treating and disrupt the layer 22 as they escape from the heat treated assembly.”

Referring again to FIG. 1, and to the portions 16, 18, 22, 24, and 26 of the fired image (that is collectively comprised of all of such portions 16 et seq.), because such portions 16 et seq. have been subjected to a temperature of at least 500 degrees Centigrade for about 6 minutes, they each contain less than about 10 weight percent of elemental carbon, and they each contain less than about 5 weight percent of hydrocarbon material(s).

In one embodiment, the fired image 13 (comprised of portions 16 et seq.) is a heterogeneous mixture comprised of glass frit, opacifiers, and pigment. The unfired image is a heterogeneous mixture comprised of glass frit, opacifiers, metal oxide, pigment and thermoplastic binders and wax.

In one embodiment, such a fired image 13 (comprised of portions 16 et seq.) is comprised of from about 25 to about 100 weight percent of glass frit, from about 0 to about 60 weight percent of opacifying agent, and from about 0 to about 50 weight percent of inorganic pigment. In one embodiment, such fired image is preferably comprised of from about 45 to about 100 weight percent of glass frit, from about 5 to about 40 weight percent of opacifying agent, and from about 0 to about 30 weight percent of inorganic pigment. In another embodiment, such fired image is comprised of from about 45 to about 75 weight percent of glass frit, from about 10 to about 25 weight percent of opacifying agent, and from about 1 to about 15 weight percent of inorganic pigment.

Such a fired image 13 (comprised of sections 16 et seq.) is adhered to substrate 12 in such a manner that it cannot be mechanically separated from said substrate without damaging the substrate 12. As will be apparent, the digitally fired image 13 is comprised of fired portions represented by 16, 18, 22, 24, and 26 as well as “voids” represented by 15, 17, 19, and 21.

The voids 15, 17, 19, and 21 might be portions of the unfired image that have been eroded during heat treatment. Alternatively, or additionally, one or more of such voids might be areas which had inadvertently not been printed in the digital image, or were damaged or removed in another process step in the preparation of the fired image 13 or the imaged substrate.

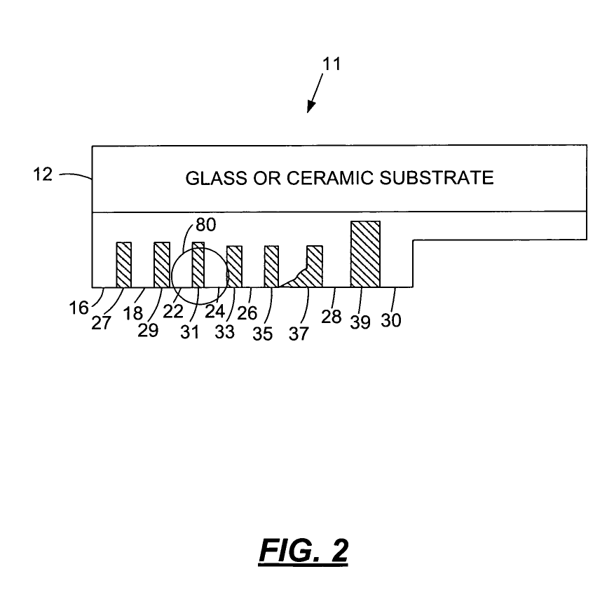

In one embodiment, one or more of such voids 15, 17, 19, and/or 21 are filled with the ceramic correction fluid of this invention. Such an embodiment is illustrated in FIG. 2.

Referring to FIG. 2, and in the embodiment depicted therein, the fired substrate assembly 11 is comprised of substrate 12, a fired image 13 disposed above the substrate 12, and digitally fired image portions 16, 18, 22, 24, 26, 28, and 30. Disposed between the digitally fired image portions 16 et seq. are patched areas 27, 29, 31, 33, 35, 37, and 39 that are preferably comprised of the cured digital ceramic correction fluid of this invention. Additionally, the image need not be applied or affixed to the substrate 12 in its final form before correction. The image may be corrected on a decal or the substrate 12 before firing, or alternatively, if a film is being used, on the film before or after application to the substrate 12.

Referring again to FIG. 2, the patched areas 27, 29, 31, 33, 35, 37, and 39 are preferably produced by disposing a specified ceramic correction fluid of this invention within the voids 15 and/or 17 and/or 19 and/or 21 (see FIG. 1), and/or one or more other such voids, and allowing the ink to air dry.

In one embodiment, the digital ceramic correction fluid of this invention is comprised of at least 10 weight percent of particles that are translucent, opaque, transparent, or mixtures thereof, depending on the type of image and substrate being corrected, with an average particle size of from about 0.1 to about 20 microns and, more preferably, from about 0.1 to about 10 microns. Translucent particles have the property of reflecting a part and transmitting a part of incident radiation. One may use any of the translucent particles known to those skilled in the art, provided they have the required particle size; these particles preferably scatter light in the visible wavelength range. Opaque particles may also be included in order to match the color or opacity of the image to be corrected. Transparent particles may also be included to match the color of the image to be corrected.

Thus, e.g., one may use one or more of the translucent particles disclosed in U.S. Pat. No. 3,633,425 to Sanford (Chromatic Temperature Indicator), U.S. Pat. No. 4,007,044 to Shiga (Color electrophotographic process), U.S. Pat. No. 4,085,246 to Buser (Simulated granite and its preparation), U.S. Pat. No. 4,159,301 to Buser (Simulated granite and its preparation), U.S. Pat. No. 4,294,902 to Takashima (Image formation method having translucent particles containing a coloring agent and a colorless dye former), U.S. Pat. No. 4,927,686 to Colea (Colbar art), U.S. Pat. No. 5,303,310 to Grove (Method and apparatus for image analysis of composite ores), U.S. Pat. No. 5,430,629 to Belliveau (Fluid-filled colored light pattern generator), U.S. Pat. No. 5,506,762 to Ziegler (Fluid-filled colored light pattern generator with twist cap), U.S. Pat. No. 5,940,215 to Rudisill (Discretely applied diffuser structure on lightguides), and the like. The entire disclosure of each of these United States patents is hereby incorporated by reference into this specification. One may also use glass or ceramic frits or fluxes, oxides such as titanium dioxide, silica, etc. or organic pigments as needed for color matching. Of course the choice of pigment must be made with an understanding of the effects of any subsequent processing (such as firing) on the properties of the included particles.

In one embodiment, the translucent particles comprise or consist essentially of an inorganic mineral, such as quartz, cerussite, amber, calcite, diamond, chelkarite sodium chloride, a variety of silicates, aluminates, and the like. In another embodiment, the translucent particles comprise a metallic oxide of silicon, boron, sodium, potassium, lead, tin, bismuth, aluminum, germanium, etc. In yet another embodiment, the translucent material is an amorphous material, such as ground glass. By way of further illustration and not limitation, the translucent materials are comprised of or consist essentially of polymeric particles such as, e.g., matte beads, polymer latices, polymeric powders, polymethylsilsesquioxane or other silicone or sol-gel types of particles and/or materials, and the like.

In one embodiment, the translucent particles used are “flux” or “frit” particles. In one aspect of this embodiment, a film-forming frit is used.

In one embodiment, the frit used has a melting temperature of at least about 300 degrees Celsius and, more preferably, about 550 degrees Celsius. As used in this specification, the term frit refers to a glass which has been melted and quenched in water or air to form small friable particles which then are processed for milling for use as the major constituent of porcelain enamels, fritted glazes, frit chinaware, and the like. See, e.g., page 111 of Loran S. O'Bannon's “Dictionary of Ceramic Science and Engineering,” supra. As used herein, the terms frit and flux are used interchangeably.

One may use commercially available frits. Thus, by way of illustration and not limitation, one may use a frit sold by the Johnson Matthey Ceramics Inc. (498 Acorn Lane, Downington, Pa. 19335) as product number 94C1001 (“Onglaze Unleaded Flux”), 23901 (“Unleaded Glass Enamel Flux,”), and the like. One may use a flux sold by the Cerdec Corporation of P.O. Box 519, Washington, Pa. 15301 as product number 9630.

In one embodiment, the melting point of the frit used is at least 50 degrees Celsius lower than the melting point of the opacifying agent optionally used in the ceramic correction fluid of this invention. In one aspect of this embodiment, the melting point of the frit used is at least about 100 degrees Centigrade lower than the melting point of the opacifying agent. This is advantageous particularly when the correction is to be fired on the substrate.

The frit used in the ceramic correction fluid preferably has a particle size distribution such that substantially all of the particles are smaller than about 20 microns. In one embodiment, at least about 90 weight percent of the particles are smaller than 10 microns.

One may use many of the frits known to those skilled in the art such as, e.g., those described in U.S. Pat. No. 5,562,748 to Huber (Manufacturing internally printed laminated glass panes); U.S. Pat. No. 5,476,894 to Huber (Color paste for manufacturing internally printed laminated glass panes); U.S. Pat. No. 5,132,165 to Blanco (Wet printing techniques); U.S. Pat. No. 3,956,558 to Blanco (Ceramic decalcomania and method); U.S. Pat. No. 3,898,362 to Blanco (Ceramic decalcomanias including design layer free of glass); and the like. Similarly, one may use some of the frits disclosed on pages 70-79 of Richard R. Eppler et al.'s “Glazes and Glass Coatings” (The American Ceramic Society, Westerville, Ohio, 2000).

In one embodiment, the ceramic correction fluid of this invention comprises at least about 15 weight percent of one or more frits, by total weight of composition. In one embodiment, from about 25 to about 85 weight percent of frit material is used. In another embodiment, from about 55 to about 75 percent of such frit material is used.

The ceramic correction fluid should be 5% to 100% solids by weight, preferably 15% to 100% solids, more preferably 25% to 75% solids. The solids are comprised of the binder and particles. Additionally, any additive known to those skilled in the art, eg, dispersants, rheology modifiers, defoamers, etc., could also be included as needed. Low solids inks tend to dry more slowly and be of lower viscosity. Rheology control, based on the selection of binders, particles, etc. offers a practical limit on the high end of solids for a given composition. In one embodiment, 100% solids are used when the binder is low enough in molecular weight as could be the case for a UV curable system. Of the solids, particles comprise 5% to 90%; preferably, the particles comprise 10% to 85% of the solids; more preferably, the particles comprise 30% to 80% of the solids.

The binder used is preferably comprised of a thermoplastic binder material, and it is preferably used at a concentration of from about 33 to about 80 weight percent, by weight of binder and frit. In one embodiment, the binder comprises at least about 50 weight percent of the composition, by total weight of frit and binder.

One may use one or more of ink binders known to those skilled in the art. Thus, e.g., one may use one or more of the binders as disclosed in U.S. Pat. No. 6,127,316 to Chapman (Orange dye mixture for thermal color proofing); U.S. Pat. No. 6,124,239 to Chapman (Orange dye mixture for thermal color proofing); U.S. Pat. No. 6,114,088 to Wolk (Thermal transfer element for forming multilayer devices); U.S. Pat. No. 6,113,725 to Kronzer (Printable heat transfer material having cold release properties); U.S. Pat. No. 6,083,610 to Hirose (Thermal transfer sheet); U.S. Pat. No. 6,031,556 to Tutt (Overcoat for thermal imaging process); U.S. Pat. No. 6,031,021 to Kenny (Thermal transfer ribbon with thermal dye color palette); U.S. Pat. No. 6,013,409 to Chou (Dry peel-apart imaging process); U.S. Pat. No. 6,008,157 to Takeuchi (Thermal transfer sheet); U.S. Pat. No. 5,985,076 to Misuda (Coated paper and methods for its preparation); and the like. The entire disclosure of each of these United States patents is hereby incorporated by reference into this specification.

By way of further illustration, one may use a binder which preferably has a multiplicity of polar moieties such as, e.g., carboxyl groups, hydroxyl groups, chloride groups, carboxylic acid groups, urethane groups, amide groups, amine groups, urea, epoxy resins, and the like in order to provide good adhesion to the film, glass, ceramic, or other substrate. Some suitable binders within this class include polyester resins, bisphenol-A polyesters, polyvinyl chloride, copolymers made from terephthalic acid, poly(methylmethacrylate), vinylchloride/vinylacetate resins, epoxy resins, nylon resins, urethane-formaldehyde resins, polyurethane, mixtures thereof, and the like.

In one embodiment a mixture of two synthetic resins is used. Thus, e.g., one may use a mixture comprising from about 40 to about 60 weight percent of poly(methylmethacrylate) and from about 40 to about 60 weight percent of vinylchloride/vinylacetate resin. In this embodiment, these materials collectively comprise the binder.

In one embodiment, the binder comprises polybutylmethacrylate and polymethylmethacrylate, comprising from 10 to 30 percent of polybutylmethacrylate and from 50 to 80 percent of the polymethylmethacrylate. In one embodiment, this binder comprises cellulose acetate propionate, ethylenevinylacetate, vinyl chloride/vinyl acetate, urethanes, etc.

One may obtain these binders from many different commercial sources. Thus, e.g., some of them may be purchased from Dianal America Company of 9675 Bayport Blvd., Pasadena, Tex. 77507; suitable binders available from this source include “Dianal BR 113” and “Dianal BR 106.” Similarly, suitable binders may also be obtained from the Eastman Chemicals Company (Tennessee Eastman Division, Box 511, Kingsport, Tenn.).

Ultraviolet (UV) curable binders or other thermosetting binders may also be used. UV binders may provide an advantage in that they can be prepared without additional solvent in the formulation.

The particles in the ceramic correction fluid of this invention may optionally comprise from about 0.1 to about 66 weight percent of opacifying agent. As is known to those skilled in the art; the opacification agent functions to introduce grayness, whiteness or opacity by utilizing a substance that disperses in a coating as discrete particles which scatter and reflect some of the incident light.

In one embodiment, from about 0.25 to about 50 weight percent of opacifying agent is used. In another embodiment, less than 40 weight percent of opacifying agent is used. In yet another embodiment, less than 25 weight percent of opacifying agent is used. In yet another embodiment, less than about 10 weight percent of opacifying agent is used.

One may use opacifying agents that are known to work with ceramic substrates. Thus, e.g., one may use one or more of the agents disclosed in U.S. Pat. No. 6,022,819 to Panzera (Dental porcelain composition); U.S. Pat. No. 4,977,013 to Ritchie (Transparent conductive coating); U.S. Pat. No. 4,895,516 to Hulten (Intermediate ceramic bonding layer for bonding of a resin to an alloy structure or substructure); U.S. Pat. No. 3,899,346 to Ferrigno (Opacity modified pigmentary compositions); and the like. The disclosure of each of these United States patents is hereby incorporated by reference into this specification.

One may obtain opacifying agents from, e.g., Johnson Matthey Ceramic Inc., supra, as, e.g., “Superpax Zirconium Opacifier.”

The opacification agent used, in one embodiment, preferably has a melting temperature at least about 50 degrees Celsius higher than the melting point of the frit(s) used. Generally, the opacification agent(s) has a melting temperature of at least about 350 degrees Celsius. This is advantageous if the image correction is to be subjected to a firing cycle.

The opacification agent, in one embodiment, has a refractive index of greater than 1.7 and, preferably, greater than 2.0.

The opacification agent, in one embodiment, preferably has a particle size distribution such that substantially all of the particles are smaller than about 20 microns and, more preferably, about 10 microns. In one embodiment, at least about 90 weight percent of the particles are smaller than 10 microns.

In one embodiment, the particles of the ceramic correction fluid of this invention are optionally comprised of less than about 75 weight percent of colorant when glass frits are also included in the correction ink. Colorants can be inorganic or organic in nature. Organic pigments should be chosen to have appropriate durability if used, and generally should not be used if the correction is to be subjected to a firing or tempering cycle. Organic pigments may comprise up to 100% of the particles in the correction ink if they are to be used. If the substrate is to be fired after correction, suitable glass, ceramic, and/or inorganic pigments should be chosen. Similarly, the particles should be chosen to provide an appropriate optical property match (color, opacity, etc.) for the finished corrected substrate use.

In one embodiment, the amount of colorant (pigment) used in the ceramic correction fluid does not exceed a certain percentage of the total amount of frit used in such composition, generally being 33.33 percent or less when the substrate is to be fired or tempered after correction. Put another way, the ratio of the total amount of frit in the composition to the amount of pigment in the composition, in grams/grams, dry weight, should be at least about 1.2 and, preferably, should be at least about 2. In one embodiment, such ratio is at least 3.0. In another such embodiment, such ratio of frit/pigment is from about 5 to 6.

In one embodiment, the colorant used in applicants' ceramic correction fluid contains at least one metal-oxide. Thus, a blue colorant can contain the oxides of a cobalt, chromium, aluminum, copper, manganese, zinc, etc. Thus, e.g., a yellow colorant can contain the oxides of one or more of lead, antimony, zinc, titanium, vanadium, gold, and the like. Thus, e.g., a red colorant can contain the oxides of one or more of chromium, iron (plus two valence), zinc, gold, cadmium, selenium, or copper. Thus, e.g., a black colorant can contain the oxides of the metals of copper, chromium, cobalt, iron (plus two valence), nickel, manganese, and the like. Furthermore, in general, one may use colorants comprised of the oxides of calcium, cadmium, zinc, aluminum, silicon, etc.

Suitable pigments and colorants are well known to those skilled in the art. See, e.g., U.S. Pat. No. 6,120,637 to Barry (self-adhesive labels and manufacture thereof); U.S. Pat. No. 6,108,456 to Yamamoto (Image processing system); U.S. Pat. No. 6,106,910 to Tan (Print media with near infrared fluorescent sense mark and printer therefore); U.S. Pat. No. 6,103,389 to Tanaka (Thermal transfer recording medium); U.S. Pat. No. 6,083,872 to Adkins (Protective overlays for thermal dye transfer prints); U.S. Pat. No. 6,077,594 to Roth (Thermal transfer ribbon with self generating silicone resin backcoat); U.S. Pat. No. 6,075,927 to Sakai (Image communication apparatus and method selectively recording a color or monochrome pattern image in response to received image information); U.S. Pat. No. 6,057,028 to Tan (Multilayered thermal transfer medium for high speed printing); U.S. Pat. No. 6,040,269 to Imoto (Method for forming image on object and thermal transfer sheet and thermal transfer image-receiving sheet for use in said method); U.S. Pat. No. 6,040,267 to Mano (Image forming method); U.S. Pat. No. 6,031,021 to Kenny (Thermal transfer ribbon with thermal dye color palette); U.S. Pat. No. 6,004,718 to Shinohara (Transfer material for use in thermal transfer and method of forming thermal transfer images); U.S. Pat. No. 5,977,263 to Ho (Multilayer graphic article with color layer); and the like. The disclosure of each of these United States patents is hereby incorporated by reference into this specification.

Organic pigments may also be used. High performance pigments with good durability and UV stability such as used in automotive paints, window films, and outdoor signage applications are particularly advantageous in the application. Such pigments are described in U.S. Pat. No. 6,884,289 to Schoen (Colored pigments); U.S. Pat. No. 6,872,245 to Grimm (Azo pigments); U.S. Pat. No. 6,870,062 to Cyr (Thermally stable, anthraquinone colorants containing copolymerizable vinyl groups); U.S. Pat. No. 6,869,472 to Bäbler (2,9-dichloroquinacridone pigment); U.S. Pat. No. 6,864,371 to Bäbler (Preparation of beta quinacridone pigments); and U.S. Pat. No. 6,833,184 to Damnjanovic (Pigmented window film). Any other suitable organic pigment as known to those skilled in the art may also be used.

By way of further illustration, some of the pigments which can be used in this embodiment of the process of this invention include those described in U.S. Pat. No. 6,086,846 to Burow (Use of synthetic, iron raw materials for preparing iron oxide pigments); U.S. Pat. No. 6,077,797 to Sperlich (Green decoration coloring substance for high-temperature firing, process for its production and use thereof); U.S. Pat. No. 6,075,223 to Harrison (High contrast surface marking); U.S. Pat. No. 6,045,859 to Klein (Method for the coloring of ceramic surfaces); U.S. Pat. No. 5,988,968 to Hansmeier (Method of and apparatus for application of adhesive); U.S. Pat. No. 5,968,856 to Schweiger (Sinterable lithium disilicate glass ceramic); U.S. Pat. No. 5,962,152 to Nakamura (Ceramic heat insulating layer and process for forming same); U.S. Pat. No. 5,912,064 to Azuma (Dial plate for solar battery powered watch); U.S. Pat. No. 5,897,885 to Patticrew (Apparatus for molding dental restorations); U.S. Pat. No. 5,895,511 to Kwon (Plasma etching apparatus); U.S. Pat. No. 5,820,991 to Cabo (Fused glass sheets having ceramic paint and metal foil and method of making same); U.S. Pat. No. 5,702,520 to Boaz (Method of making water based paint and formed glazing with paint thereon); and the like. The entire disclosure of each of these United States patents is hereby incorporated by reference into this specification.

It is preferred that the colorant have a particle size distribution such that at least about 90 weight percent of its particles are within the range of 0.1 to 20 microns.

The pigment used, in one embodiment, preferably has a refractive index greater than 1.4 and, more preferably, greater than 1.6.

The choice of binder and particles should be made in light of the final application. If one desires to correct the image, then subject the imaged substrate to a firing or tempering cycle, the binder should be chosen to burn cleanly during the cycle, and the particles chosen to provide the desired characteristics (color, opacity, durability, etc.) after firing. If the imaged substrate correction is the last step in its production, the binder should be chosen to provide the needed adhesion and durability and the particles to provide their desired characteristics without further heat treating of the imaged substrate. Similarly, if correction is done on an imaged film, binder and particles in the ink should be chosen to suit such an application. It is desirable to ensure the image is patched such that the void portions and the imaged portions are matched such that a viewer fails to notice the patching upon a cursory inspection of the substrate. Suitable matching technology is known to those skilled in the art.

One such matching technology uses Delta-E values to ensure a proper match. As is known by those skilled in the art, a Delta-E value measures the degree of visual matching between two images. The lower the Delta-E value, the more perfectly matched the two images are. Reference may be had to U.S. Pat. No. 6,309,426 to Dias (Hair coloring composition), the content of which is hereby incorporated by reference into this specification. A Delta-E value of less than about 5 is typically unnoticeable to the untrained eye. A more sensitive view may be able to detect differences with a Delta-E value of approximately 3. In one embodiment, the imaged portions and the void portions are matched such that they have a Delta-E of less than about 10. In another embodiment, the Delta-E value less than about 5. In yet another embodiment, the Delta-E value is less than about 3.

In addition, as known to those skilled in the art, other ink additives, such as rheology modifiers, dispersants, defoamers, antimicrobial agents, etc. may be used to aid in the production or usage of the correction ink.

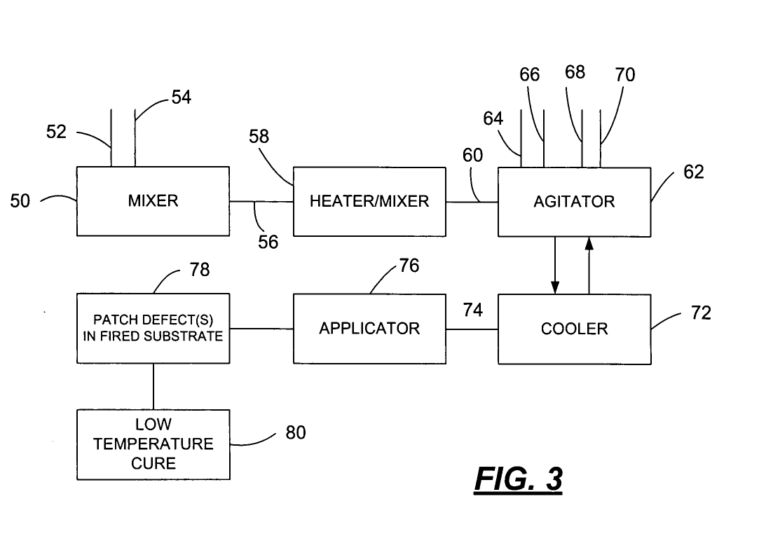

The ceramic correction fluid of this invention may be prepared in substantial accordance with the flow diagram depicted in FIG. 3. Other processes for preparing particle dispersions, as known to those skilled in the art, may also be used.

Referring to FIG. 3, and in the embodiment depicted therein, the mixer 50 is charged liquid medium via line 52. The liquid medium preferably has a low shear viscosity less than 100 centipoise. The liquid medium may be aqueous or non-aqueous. It may be a pure compound or a mixture of miscible liquids. The liquid medium should have the ability to dry under ambient conditions.

In one embodiment, although most oils are not suitable for such applications, drying oils which oxidatively crosslink may be used. Oils could also be used if adequate dry time can be allowed.

In one embodiment, the liquid is an organic solvent. One may use any of the organic solvents conventionally used in the preparation of inks. Thus, e.g., one may use one or more of the organic solvents described in U.S. Pat. No. 3,793,053 to Benford (Glass decoration), U.S. Pat. No. 4,388,347 to Shum (Conductive pigment-coated surfaces), U.S. Pat. No. 4,522,654 to Chisvette (Continuous method of producing phthalocyanine pigment dispersions in organic solvent), U.S. Pat. No. 4,710,401 to Warren (Method of printing electrically conductive images on dielectric substrates), U.S. Pat. No. 4,968,553 to Cesar (Graphic architectural glass), U.S. Pat. No. 5,069,719 to Ono (Organic solvent based ink composition), U.S. Pat. No. 5,091,004 to Tabayashi (Ink Composition), U.S. Pat. No. 5,124,282 to Prabhu (Glasses and overglaze inks made therefrom), U.S. Pat. No. 5,268,024 to Moran (Formation of inorganic conductive coatings on substrates), U.S. Pat. No. 5,298,535 to Kammer (Pigment compositions for solvent and water-based ink systems and the methods for producing them), U.S. Pat. No. 5,366,760 to Fujii (Conductive ink composition and method of forming a conductive thick film pattern), U.S. Pat. No. 5,380,769 to Titterington (Reactive ink compositions and systems), U.S. Pat. No. 5,665,472 to Tanaka (Thermal transfer sheet), U.S. Pat. No. 5,990,197 to Escano (Organic solvent based ink for invisible marking/identification), U.S. Pat. No. 5,971,646 to Chavatte (Writing implement using liquid ink, in particular a solvent-based ink), U.S. Pat. No. 5,997,849 to Small (Thermochromic ink formulations, nail lacquer and methods of use), U.S. Pat. No. 6,221,140 to Kobayashi (Ink jet ink containing an organic metal complex), U.S. Pat. No. 6,537,359 to Spa (Conductive ink or paint), and the like. The entire disclosure of each of these United States patents is hereby incorporated by reference into this specification.

Referring again to FIG. 3, and in the embodiment depicted therein, it is preferred to charge from about 15 to about 95 weight percent of liquid medium via line 52, by total weight of the mixture in mixer 50. In one embodiment, from about 25 to about 75 weight percent of such liquid, such as solvent grade toluene, is charged. In another embodiment, from about 25 to about 75 weight percent of such liquid is water.

Referring again to FIG. 3, thermoplastic binder (described elsewhere in this specification) is charged via line 54. It is preferred to charge from about 1 to about 85 dry weight percent of the binder by total weight of the mixture. In one embodiment, from about 15 to about 75 weight percent of such binder is charged.

Thereafter, and referring again to FIG. 3, the mixture of liquid and binder is conveyed via line 56 to heater/mixer 58, wherein the mixture is heated with agitation until the mixture is homogeneous. In one embodiment the mixture is heated to 70° C. In another embodiment the mixture is heated to 25° C.

Thereafter, the substantially homogeneous blend of liquid and binder from heater/mixer 58 is fed via line 60 to agitator 62. To agitator 62 is fed milling media, via line 64. The milling media is preferably ceramic milling media. In one embodiment, the milling media (not shown) are present in the agitator 62 prior to the time the homogeneous blend of liquid and binder is conveyed via line 60.

One may use the milling media known to those skilled in the art. Thus, e.g., one may use one or more of the milling media described in U.S. Pat. No. 3,754,712 to Cecil (Preparation of a stable suspension of calcined clay); U.S. Pat. No. 4,651,935 to Samosky (Horizontal media mill); U.S. Pat. No. 5,478,705 to Czekai (Milling a compound useful in imaging elements using polymeric milling media); U.S. Pat. No. 5,500,331 to Czekai (Comminution with small particle milling media); U.S. Pat. No. 5,668,068 to Prochazka (Sintered silicon carbide and method of making); U.S. Pat. No. 6,309,749 to Chatterjee (Ceramic milling media containing tetragonal zirconia); U.S. Pat. No. 6,499,680 to Schillaci (Grinding media); U.S. Pat. No. 6,604,698 to Verhoff (Media milling), and the like. The entire disclosure of each of these United States patents is hereby incorporated by reference into this specification. Alternatively, one may also use any mixing method known to those skilled in the art for dispersing particles in a solution.

Referring again to FIG. 3, and to the embodiment depicted therein, from about 0.5 to about 75 parts by weight of particles (such as, e.g., glass frit) are fed via line 66. The concentration of particles is by total weight of binder and particles such as those described elsewhere in this specification, both on a dry weight basis. Thereafter, from about 0 to about 60 weight percent of opacifying agent, such as those described elsewhere in this specification, is fed via line 68, and from about 0 to about 60 weight percent of colorant, such as those described elsewhere in this specification, is added via line 70.

The mixture thus formed in agitator 62 is then agitated until it has a Hegman grind of from about 4 to about 7.5. As is known to those skilled in the art, the Hegman grind is a means of determining the fineness of grind of pigments in liquid paints, inks, and related products using a suitable gauge. The gauge is a steel block into which is machined a groove which is uniformly tapered along its length from 100 microns at one end to zero at the other end. A scale denotes the depth of the groove at any point along its length. A portion of the sample is placed in the groove at the deep end and a blade used to draw the liquid down the length of the groove.

When the gauge is viewed at an angle, it is possible to note the point along the length of the groove where it becomes shallow enough for the pigment particles to protrude above the level of the liquid. The pigment particle size at this point can be read form the scale. For example, when the Hegman reading is 4, the particle size of the dispersion is less than or equal to 50 microns, when the Hegman reading is 7, the particle size of the dispersion is less than or equal to 10 microns. Reference may be had, e.g., to U.S. Pat. No. 4,391,855 to Geeck (Corrosion resistant coating and method for coating metal substrate); U.S. Pat. No. 4,544,581 to Pelloski (Black corrosion resistant coating and method for a metal substrate); U.S. Pat. No. 4,619,705 to Dixon (Nonionic surfactant treated clays, methods of making same, water-based paints, organic solvent-based paints and paper coatings containing same); U.S. Pat. No. 5,282,887 to Gay (Conductive coating composition comprising pigment grade carbon); U.S. Pat. No. 5,558,708 to Johansen (System and method for dispersing pigment in cement based compositions), and the like. The entire disclosure of each of these United States patents is hereby incorporated by reference into this specification.

In one process, illustrated in FIG. 3, the ceramic correction fluid is agitated for a certain period of time, and during such agitation its temperature rises. The agitation is ceased (in step 72) until the mixture cools to about ambient temperature, and then the agitation resumes (in agitator 62). This process is repeated until a ceramic correction fluid with the desired Hegman grind is produced, and it is then allowed to cool in cooling step 72. Of course, cooling simultaneously to the agitation is preferred to shorten the mixing time and increase the efficiency of the process. One skilled in the art could use any suitable process for dispersing particles in liquids.

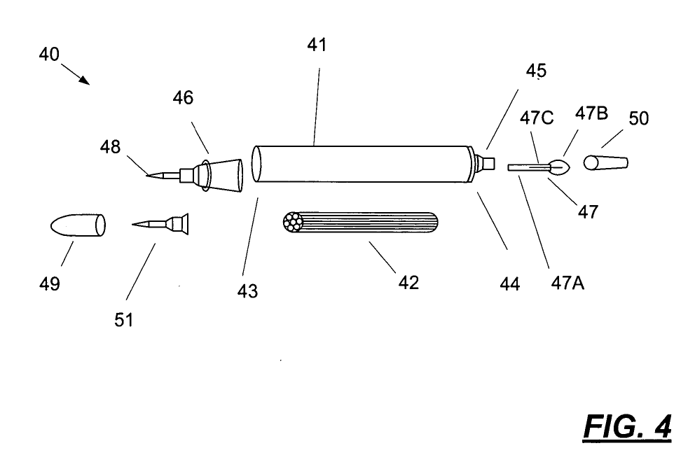

The cooled ceramic correction fluid is then discharged via line 74 to an applicator 76. The applicator may, e.g., be the pen described in FIG. 4.

In step 78, the dispenser 78 is used to patch one or more defects in a fired substrate, as is best illustrated in FIG. 2. Thereafter, in step 80, the patched substrate is allowed to cure, preferably at a temperature of less than about 80 degrees Centigrade. In one embodiment, the patched substrate is allowed to cure at a temperature of from about 20 to about 70 degrees Centigrade.

Referring again to FIG. 2, the patched, fired substrate assembly 11, and to the portion of the fired substrate 11 depicted in circle 80, it will be seen that the fired substrate is comprised of a surface with a multiplicity of fired portions (e.g., portions 22 and 24) adjacent to and/or contiguous with one or more patched areas (such as, e.g., patched area 31).

In one embodiment, the fired portions (e.g., portions 22 and 24) preferably contain less than about 5 weight percent of hydrocarbon material and, more preferably, less than about 1 weight percent of hydrocarbon material. The patched areas (e.g., patched area 31) contain at least about 10 weight percent of hydrocarbon material, and generally contain at least about 40 weight percent of hydrocarbon material.

In one embodiment, the refractive index of the fired portion is greater than about 1.4.

The fired portions (e.g., portions 22 and 24) and the patched areas (e.g., patched area 31) generally have optical properties that are substantially identical, being within about plus or minus ten percent of each other. Thus, among the similar optical properties they so share include, e.g., color, opacity, transmission density, and reflection density.

FIG. 4 is a schematic illustration of one ink applicator for use with the present invention. As illustrated in FIG. 4, ink applicator 40 is comprised of body 41, ink reservoir 42, first end 43 and a second end 44, marking tip holders 45 and 46, marking tips 47 and 48, and marking tip caps 49 and 50. In the embodiment depicted, body 41 is hollow and is configured to receive ink reservoir 42. First end 43 of body 41 has an opening of a sufficient diameter such that ink reservoir 42 may be easily disposed within body 41. Second end 44 is configured to receive marking tip holder 45; whereas first end 43 is configured to receive marking tip holder 46. Each of these marking tip holders is, in turn, adapted to receive marking tips of various sizes. Thus, in the embodiment depicted, marking tip holder 46 is adapted to receive fine marking tip 48, whereas marking tip holder 45 is adapted to receive course marking tip 47. Alternate marking tips, such as marking tip 51, may be attached to body 41. In this manner, a variety of marking tips with various sizes may be used in conjunction with ink applicator 40. The marking tip holders 45 and 46 are configured such that they may be disposed in either first end 43 or second end 44, thus facilitating easily replacement and/or exchange of parts. Marking tip caps 49 and 50 are configured to fit over marking tips 48 and 47 as well as marking tip holders 46 and 45, thus protecting the tips from physical damage and preventing the evaporation of volatile substances, such as, for example, the ink (not shown) contained in ink reservoir 42.

As shown in FIG. 4, marking tips 48 and 47 are adapted to convey ink from ink reservoir 42 to a substrate for marking. Thus, as depicted in FIG. 4, marking tip 47 is comprised of an ink receiving end 47A, an ink applicating end 47B, and a groove 47C. When ink applicator 40 is fully assembled and filled with ink, ink receiving end 47A is contiguous with ink reservoir 42, and conveys ink (not shown) from the reservoir 42 to the substrate (not shown) by wicking action. Groove 47C, which is optional, facilitates the wicking action of the ink through the marking tip 47.

In the embodiment shown in FIG. 4, ink reservoir 42 is comprised a plurality of porous material. For example, the porous material may be a foam, a felt, and the like. Similar materials are well known to those skilled in the art. Other pen or marker designs such as those used to dispense paint, etc., could also be used.

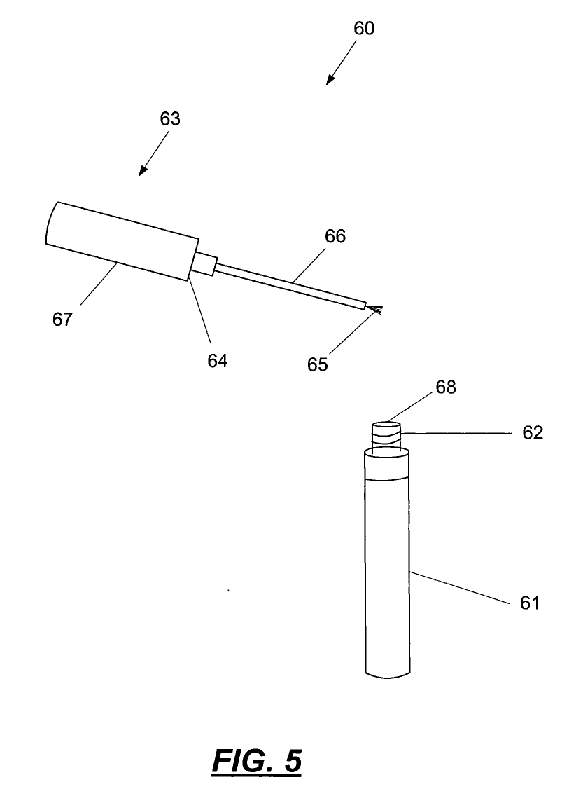

FIG. 5 is a picture of another ink applicator 60 for use with the present invention. As shown in FIG. 5, ink applicator 60 is comprised of ink reservoir 61, an opening 68, and male threads 62 adjacent to the opening 68. Male threads 62 are configured to fit into female threads 64 of applicator 63. Applicator 63 is further comprised of cap 67, shaft 66, and applicator brush 65. As is apparent from FIG. 5, to apply ink (not shown) to a substrate, one simply dips applicator brush 65 into ink reservoir 61 to retrieve a sample of ink. Again, other similar designs, e.g., nail polish bottles, lip gloss applicators, etc., may be used.

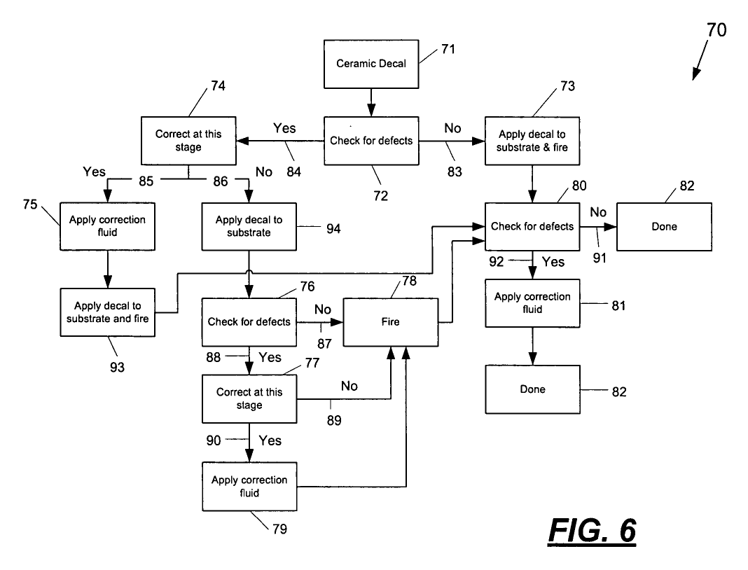

Referring to FIG. 6, the process 70 for using the correction inks (described elsewhere in this specification) to correct ceramic decals 71 is shown. In step 72 of the process, the ceramic decal is checked for image defects and a decision is made to correct the defects at this stage or not. If the decision is not to correct the defects at this stage 83 of the process 70, then the decal is applied to the substrate and fired in step 73 of the process. Again, a check for defects 80 is made and a decision point is reached as to whether or not to correct the defects at this stage. If the decision is not to correct the defects at this stage 91 of the process, then the imaged substrate has been completed in step 82 of the process. If it is decided to correct the defects on the fired substrate in this stage 92 of the process, then correction inks are applied to the defects in step 81 of the process and after such corrections are made, the imaged substrate has been completed in step 82 of the process.

Again, referring to FIG. 6, if in step 72 of the process 70 defects are found which require correction 84, then a decision is made in step 74 of the process to correct the defects at this stage or not. If the decision is to correct the defects in this stage 85 of the process, then correction ink is applied to the defects on the decal in step 75 of the process. The decal is then applied to the substrate and fired in step 93 of the process 70. A secondary check for defects on the imaged substrate takes place in step 80 of the process and the process continues as describe previously in this specification.

Again, referring to FIG. 6, in step 74 of process 70, a decision is made not to correct the defects on the decal at this stage 86 of the process, then the decal is applied to the substrate in step 94 of the process. Again an inspection for defects is made on the laminated substrate in step 76. If the decision is not to make any corrections at this stage 87 of the process, the laminated substrate is fired in step 78 of the process 70. The imaged substrate then undergoes a final check for defects in step 80 of the process and the process continues as described previously in this specification.

Again, referring to FIG. 6, in step 76 of the process if defects are detected then a decision can be made at this stage 88 of the process to correct the defects or not. If in step 77 of the process 70 the decision is made to not correct the defects at this stage 89 of the process then the laminated substrate is fired in step 78 of the process. The imaged substrate then undergoes a final check for defects in step 80 of the process and the process continues as described previously in this specification.

Again, referring to FIG. 6, in step 77 of the process 70 the decision is made to correct the defects at this stage 90 of the process, then correction ink is applied to the laminated substrate in step 79 of the process. The laminated substrate is then fired in step 78 of the process. The imaged substrate then undergoes a final check for defects in step 80 of the process and the process continues as described previously in this specification. If a film is being used, the image can be corrected before or after the image is applied to the substrate.

In one embodiment, each of the fired portions (e.g., portions 22 and 24) and the unfired portions (e.g., portion 31) have a peel test result of about less than 10% ink removed. The peel test is described in detail below. As is apparent to those skilled in the art, this peel test value is a measure of the strength with which the portion in question adheres to the substrate 12.

Tape Susceptibility

As used in this specification, the term “tape susceptibility” refers to the amount of ceramic correction coating that is removed from the substrate in accordance with ASTM D3359 test method B. Ceramic correction ink coatings for tape susceptibility testing were prepared on a 305 mm by 305 mm piece of 6 mm thick float glass. A 114 mm wide bird type applicator (part number AP-3×0005 TS, supplied by Paul N. Gardner Company Incorporated, 316 NE First St., Pompano Beach, Fla.), with a coating width of 76 mm was used to applied the liquid correction ink to the glass substrate at a wet film thickness of 12 microns, drawing the ink down the entire length of the substrate, creating a uniform coating. All ceramic correction ink coatings prepared were dried at room temperature; about 22 degrees C. Dried correction coatings were tested for tape susceptibility at intervals of 30 min., 1 hr., 2 hr., 4 hr., 8 hr. and 24 hr after coating. In accordance with ASTM D3359, the dried correction ink coatings were crosshatched with eleven cuts 20 mm long and spaced 1 mm apart in each direction. One test was performed at each time interval for each ink. As the ceramic correction ink coating used in this test consists of only one layer on the glass substrate; all failures occurred between the ink coating and the substrate. The tape used in this testing was 3M 622 high tack tape (from 3M, 3M Center, St. Paul, Min.).

Chemical Susceptibility

As used in this specification, the term “Chemical Susceptibility” refers to the amount of the dried ceramic correction ink that is removed from the substrate in accordance with the following procedure: A 1.5 millimeter by 1.5 millimeter square of ceramic correction fluid is applied to a glass substrate. After a 24 hour period of cure time at a temperature of about 22° C., the correction ink patch is evaluated for chemical susceptibility by placing two drops of the test liquid onto the dried correction ink. The liquid is allowed to remain on the correction ink patch for thirty seconds. After thirty seconds the test liquid is removed by wiping with a cloth. The remaining correction ink patch on the substrate is visually inspected and the percent removal is estimated. For a “2-isopropanol susceptibility” test, the test liquid is reagent grade 2-isopropanol (CAS 67-63-0). For a “toluene susceptibility” test, the solvent is reagent grade toluene (CAS 108-88-3). Other solvents may be tested in a similar fashion. For a “glass cleaner susceptibility” test, a generic glass cleaner was made by mixing 50 g of water, 50 g of 2-propanol, 50 g of 5% aqueous ammonium hydroxide solution (5 g ammonium hydroxide in 100 mL of solution) and 2.5 g of glycol ether EB (Ethylene Glycol Monobutyl Ether, CAS#: 111-76-2 purchased from Lyondell Chemical Company, 1221 McKinney, Suite 700, Houston, Tex. 77252-2583).

### EXAMPLE 1

A correction ink was prepared by mixing 43.58 grams of solvent grade toluene with 23.47 grams of Dianal BR113 (an acrylic copolymer purchased from Dianal America Inc., 9675 Bayport Boulevard, Pasadena, Tex.). This mixture was heated, under agitation, at 70 degrees Celsius until homogeneous at which time the solution was added to a pint sized paint can. Thereafter, 22.93 grams of 23901 glass flux (an unleaded glass enamel flux purchased from Johnson Matthey Ceramics Inc., 498 Acorn Lane, Downingtown, Pa.), 4.61 grams of Superpax Zircon Opacifier (a zirconium silicate purchased from Johnson Matthey Ceramics Inc.), 4.21 grams of Ceramic Flux 94C1001 (an onglaze unleaded flux purchased from Johnson & Matthey, 498 Acorn Lane, Dowington, Pa.), and 1.20 grams of Cerdec 1795 Black Oxide (a black pigment and silica mixture purchased from Cerdec Corporation/Ferro Corporation, Washington, Pa.) were added along with 50 grams of ceramic milling media. The paint can was then placed in a paint shaker and agitated for 32 minutes, allowing a 15 minute cooling period after each 12 minutes of agitation. When a Hegman grind of better than 7 was achieved, the ceramic media was filtered out using a 400-micron filter.

The ink so prepared was loaded into an empty Tria marker (a felt tipped marker purchased from Letraset Ltd., Kingsnorth Industrial Estate, Watton Rd., Ashford, Kent, TN23 6FL, United Kingdom). This was achieved by removing the cotton ink reservoir from the Tria marker and inserting one end into the inlet hose of a vacuum pump, which was then turned on. The ink was then added drop wise using a transfer pipette until the reservoir was saturated. After the reservoir was filled it was placed back in the Tria marker. A Tria Brush Marker Nib (purchased from Letraset Ltd.) replaced the standard, as this nib has a conical shape which is better suited to this application. The brush nib is softer than the standard nib and accepts the ink more readily. The Tria marker was then capped and allowed to sit for 15 minutes to allow the ink time to fully wet the replacement brush nib.

A checkerboard pattern of digitally printed and fired ceramic frit ink on a 6 mm thick float glass substrate was prepared as a test substrate for the correction inks. Correction inks could be applied to the unprinted voids of the checkerboard pattern and visual comparisons of the color and appearance of the correction ink to the color and appearance of the digitally printed and fired ceramic frit ink could be made. In addition, the chemical and adhesive susceptibility of the correction inks could be made after the inks had been applied and allowed to dry on the glass substrate.

A transfer decal sheet was prepared with a releasable covercoat on a flexible substrate. The flexible substrate was a 90 gram per square meter basis weight paper made from bleached softwood and hardwood fibers. The surface of the paper was sized with starch. This base paper was then coated with a release layer by extrusion coating a polyethylene and extrudable wax (Epolene, from Eastman Chemical Corporation of Kingsport, Tenn.) mixture to a coatweight of 20 gram per square meter.

A covercoat coating composition was prepared for application to the release layer of the flexible substrate. The cover coat was prepared by coating Joncryl 617 (a styrenated acrylic polymer emulsion purchased from Johnson Polymer, LLC, 8310 16^{th} Street, P.O. Box 902, Sturtevant, Wis.) at a dry coat weight of 15 grams per square meter using a Meyer rod. The coated paper was then allowed to dry at ambient temperature for 16 hours.

A ceramic frit thermal transfer ribbons was prepared for digitally printing the checkerboard pattern onto the transfer decal sheet. The ceramic frit ink to be coated on the thermal transfer ribbon was prepared by mixing 18.27 grams of toluene heated to 50 degrees centigrade with 6.59 grams of Dianal BR113 (an acrylic copolymer purchased from Dianal America Inc., 9675 Bayport Boulevard, Pasadena, Tex.), 1.62 grams of the Elvax 250 (an ethylene-vinyl acetate copolymer purchased from DuPont Polymer Products, 1007 Market Street, Wilmington, Del.), and 0.49 grams of Uniclear 100 (polyamide gellant from Arizona Chemical, P.O. Box, Jacksonville, Fla. 32225). These components were allowed to dissolve completely and then cooled to ambient temperature. Subsequently, 3.45 gram of dioctyl phthalate (Chemcentral, 3709 River Road, Town of Tonawanda, N.Y. 14150) 28.86 grams of the flux 20-8380 (Ferro Corp, Washington, Pa.), 5.32 grams of the Zirocn Opacifier Superpax Plus, 4.78 grams of the 94C1001 Flux , and 0.79 grams of the Cerdec Black oxide 1795 were added to the mixture. To the mixture was added 50 grams of 0.6/0.8 mm ER120S zirconia-silica milling media (purchased from Saint-Gobain Zirpro, 1122 Highway 22, Mountainside, N.J. 07092). The mixture was milled on a Red Devil paint shaker until a 7 hegman grind (particle size of 0-5 microns) was achieved. Then 24.31 grams of the 15% dispersion of alcohol modified paraffin wax Unilin 425 (Baker Petrolite, Sugarland, Tex.) in methyl ethyl ketone was added. The mixture was re-milled until a 7 hegman grind was achieved. The ceramic media was filtered out using a 400 micron nylon filter bag.

A heat resistant back coating ink was prepared by mixing 6.62 grams of the of Lustran SAN33 (styrene acrylonitrile copolymer from Bayer Polymers, 100 Bayer Rd. Pittsburgh, Pa.), 2.85 grams of the Zinc Sterate (Zeller & Gmelin GMBH, Schloss-Strauss 201D-7332 Elislengenfils, Germany), 0.42 grams of the Zelec NK (Dupont Corp, 1007 Market St., Wilmington, Del.), 1.83 grams of the Printex XE2 (Degussa Corp, 65 Challenger Rd., Ridgefield, N.J.) and 1.94 grams of the Homogenol L18 (KAO Specialities Americas, 243 Woodbine St., High Point, N.C.) into 86.35 grams of methyl ethyl ketone. To this mixture was added 50 grams of ceramic milling media and the mixture was milled for 16 minutes on a paint shaker. The ceramic media was then filtered out with a 400 micron filter bag. The mixture was then coated at a coatweight of 0.23 grams per square meter using a gravure coating process to a 5.7 micron thick poly(ethylene terepthalate) film (Toray Plastics America, Providence, R.I.).

The ceramic thermal transfer ink was then coated via a meyer rod at 6.5 grams per square meter onto the uncoated face side the 5.7 micron thick PET film. The ink was dried with a hot air gun until dry to the touch to complete the preparation of the ceramic frit thermal transfer ribbon.

A voided square image was prepared by printing a 110 mm wide solid square, with a repeating pattern of 1.5 mm unprinted square voids placed at 9 mm intervals across the entire area of the square, onto the transfer decal sheet of this example with the ceramic frit thermal transfer ribbon of this example. The ceramic frit ribbon prepared above was printed onto the covercoat side of the transfer decal sheet using a 140Xii Thermal Transfer printer (purchased from Zebra Technologies Corporation, 333 Corporate Woods Parkway, Vernon Hills, Ill. 60061-3109 USA) at a printing speed of 2 inches per second and a darkness setting of 26. The voided square imaged decal was then placed image side down onto a 10 cm by 10 cm square piece of 6mm thick float glass piece. This decal-glass assembly was then placed onto the lower platen of a heat press (George C. Knight Co., Piscataway, N.J.). The top platen had been previously heated to 121 degrees centigrade. The top platen was then clamped down on top of the decal/glass assembly and allowed to heat for one minute. This heating time allowed the paper temperature to reach 85 degrees centigrade. Pressure on the platen screw was set to a midway point. The image/glass assembly was then allowed to cool to ambient temperature and the paper backing was peeled away from the glass and voided square image printed covercoat.

The glass substrate with the adhesively attached, voided square image printed, covercoat was fired in a kiln at 680° C. for 2 minutes and 20 seconds. The firing bonding the ceramic frit voided square image to the glass substrate and removing most of the organic compounds from the ink and covercoat.

The brush nib of the marker containing the correction ink of this example was then used to fill in twenty of the 1.5 mm square voids on the voided square image fired glass substrate. The square voids were patched by dabbing the ink saturated applicator of dispenser onto the voids, thus transferring the ink onto the un-imaged areas of the glass, until they were completely filled in with the ink. The color of this correction ink was shown to be a good match, as one could not visually distinguish the touch up ink from the fired image when the image was backlit with sunlight and viewed from a distance of about 1 meter. Toluene susceptibility was tested first by placing two drops of solvent grade toluene onto five of the inked squares and wiping said solvent off after 30 seconds. It was noted that over 80% of the ink in this example was removed from the glass when the solvent was wiped off (toluene susceptibility of 80%). The next five of the remaining inked squares were treated with two drops of solvent grade 2-propanol. This was allowed 30 seconds of dwell time, after which the solvent was wiped off. It was observed that the coating was unaffected by this solvent (2-propanol susceptibility of 0%). The final chemical durability test was conducted by placing two drops of a generic glass cleaner onto five of the remaining inked squares and removing said generic cleaner after 30 seconds dwell time. The correction ink patch was observed to show signs of being dissolved during the dwell time and 90% of the ink was removed with the glass cleaner (glass cleaner susceptibility of 90%).

The tape susceptibility of this ink was tested in accordance with ASTM D3359 method B. A coating of the correction ink was prepared on a 305 mm by 305 mm piece of 6 mm thick glass as described above. The dried ink coating was crosshatched with a razor knife also as described above. One test was performed for each time interval. The ASTM D3359 classification of tape susceptibility at 24 hours for this correction ink was 0 since more than 65% of the dried correction coating was removed by the tape (tape susceptibility>65%).

### EXAMPLE 2

The procedure of Example 1 was substantially followed with the exception that in this correction ink the Dianal BR113 was replaced with an equal amount of Elvax 205W (an ethylene-vinyl acetate copolymer purchased from DuPont Polymer Products, 1007 Market Street, Wilmington, Del.). 50 grams of solvent grade toluene was used in order to obtain the desired ink rheology required for the applicator. An empty Tria marker was then filled with this correction ink as described in Example 1.

The correction ink was then used to fill in twenty of the 1.5 mm square voids on the voided square image fired glass substrate as described in Example 1. The correction ink patches were then tested for durability and chemical resistance in accordance with the procedure described above. In the chemical susceptibility tests, all of the correction ink was removed from the glass with each of the test liquids (100% toluene, 2-propanol and glass cleaner susceptibility). ASTM D3359 tape susceptibility classification at 24 hours was for this correction ink 0 with more than 65% of the coating being removed by the tape (tape susceptibility>65%).

### EXAMPLE 3

The procedure of Example 1 was substantially followed with the exception that in this correction ink the Dianal BR113 and all of the toluene was replaced with 67.05 grams of Dynapoll 411 (a 35% solids solution in MEK of a copolyester resin dispersion purchased from Creanova Inc., Turner Place, Box 365, Picastaway, N.J.). No further dilution was ink was necessary to control the rheology. The ink, so prepared was used to fill an empty Tria marker as described in Example 1.

The correction ink was then used to fill in twenty of the 1.5 mm square voids on the voided square image fired glass substrate as described in Example 1. The correction ink patches were then tested for durability and chemical resistance in accordance with the procedure described above. All of the dried correction ink was removed from the glass when toluene was used (100% toluene susceptibility). The correction ink was unaffected by both 2-propanol and the generic glass cleaner (0% 2-propanol and glass cleaner susceptibility). The ASTM D3359 classification for tape susceptibility of this ink at 24 hours dry time was 0; more than 65% of this ink being removed by the tape (tape susceptibility>65%).

### EXAMPLE 4

The procedure of Example 1 was substantially followed with the exception that the in this correction ink the Dianal BR113 was replaced with 6.23 grams of Therban (a hydrogenated acrylic-butadiene-acrylonitrile terpolymer purchased from Bayer Corporation, 1007 Market Street, Wilmington, Del.) and 84.68 grams of solvent grade toluene was used. The Therban was dissolved in the toluene, as described in Example 1. The formula for this correction ink was adjusted for the lower amount of binder in the ink. Accordingly, 6.23 grams of Glass Flux 23901, 1.25 grams of Superpax Zircon Opacifier, 1.14 grams of Ceramic Flux 94C1001 and 0.32 grams of Cerdec 1795 Black Oxide were added to the correction ink. The ink was milled as described in Example 1. So prepared, the ink was used to fill an empty Tria marker as described in Example 1.

The correction ink was then used to fill in twenty of the 1.5 mm square voids on the voided square image fired glass substrate as described in Example 1. The correction ink patches were then tested for durability and chemical resistance in accordance with the procedure described above. It was noted that all of the ink was removed from the glass in the chemical susceptibility tests (100% toluene, 2-propanol and glass cleaner susceptibility). ASTM D3359 classification for tape susceptibility of this ink at 24 hours was 0 with more than 65% of this ink was removed by the tape (tape susceptibility>65%).

### EXAMPLE 5

The procedure of Example 1 was substantially followed with the exception that that in this correction ink the Dianal BR113 was replaced with 23.47 grams of UCAR Vinyl Resin VROH (hydroxyl-modified vinyl copolymer purchased from Union Carbide, 39 Old Ridgebury Road, Danbury, Conn.) which was dissolved in 43.58 grams of a solution containing equal parts of solvent grade toluene and 2-butanone. So prepared, the ink was used to fill an empty Tria marker as described in Example 1.

The correction ink was then used to fill in twenty of the 1.5 mm square voids on the voided square image fired glass substrate as described in Example 1. The correction ink patches were then tested for durability and chemical resistance in accordance with the procedure described above. It was noted that 75% of the ink was removed from the glass when toluene was used (75% toluene susceptibility). This dried correction ink was unaffected by both 2-propanol and the generic glass cleaner (0% 2-propanol and glass cleaner susceptibility). ASTN D3358 classification for the tape susceptibility of this ink at 24 hours was 5; 0% of the ink was removed by the tape (0% tape susceptibility). EXAMPLE 6

The procedure of Example 1 was substantially followed with the exception that in this correction ink the Dianal BR113 and all of the toluene was replaced with 67.07 grams of Joncryl 617 (a 45.5% solids dispersion of a styrenated acrylic polymer emulsion purchased from Johnson Polymer, LLC, 8310 16^{th} Street, P.O. Box 902, Sturtevant, Wis.). So prepared, the ink was used to fill an empty Tria marker as described in Example 1.

The correction ink was then used to fill in twenty of the 1.5 mm square voids on the voided square image fired glass substrate as described in Example 1. The correction ink patches were then tested for durability and chemical resistance in accordance with the procedure described above. It was noted that about 30% of the ink was removed from the glass when toluene was used (30% toluene susceptibility) and that 10% of the ink was removed by the generic glass cleaner. It was observed that this correction ink was unaffected by 2-propanol (0% 2-propanol susceptibility). ASTM D3359 classification for the tape susceptibility of this ink at 24 hours was 5; 0% of the ink was removed by the tape (0% tape susceptibility).

### EXAMPLE 7

The procedure of Example 1 was substantially followed with the exception that in this correction ink the Dianal BR113 and all of the toluene was replaced with 67.05 grams of Genflo 557 (a 50% solids emulsion of styrene butadiene purchases from Omnova solutions Inc., 165 South Cleveland Avenue, Mogadore, Ohio). So prepared, the ink was used to fill an empty Tria marker as described in Example 1.

The correction ink was then used to fill in twenty of the 1.5 mm square voids on the voided square image fired glass substrate as described in Example 1. The correction ink patches were then tested for durability and chemical resistance in accordance with the procedure described above. It was noted that less than 10% of the ink was removed from the glass when toluene was used (<10% toluene susceptibility). While 2-propanol had no effect on this correction ink (0% 2-propanol susceptibility), this correction ink was completely removed by the generic glass cleaner (100% glass cleaner susceptibility). ASTM D3359 classification for the tape susceptibility of this ink at 24 hours was 5; 0% of the ink was removed by the tape (0% tape susceptibility).

### EXAMPLE 8

The procedure of Example 1 was substantially followed with the exception that in this correction ink the Dianal BR113 and all of the toluene was replaced with 67.05 grams of Sancure 815 (a 35% solids dispersion of a polyurethane resin in water purchased from Noveon Inc., 9911 Brecksville Road, Cleveland, Ohio). So prepared, the ink was used to fill an empty Tria marker as described in Example 1.

The correction ink was then used to fill in twenty of the 1.5 mm square voids on the voided square image fired glass substrate as described in Example 1. The correction ink patches were then tested for durability and chemical resistance in accordance with the procedure described above. It was noted that none of the ink was removed from the glass during any of the chemical susceptibility tests (0% toluene, 2-propanol and glass cleaner susceptibility). ASTM D3359 classification for the tape susceptibility of this ink at 24 hours was 5; 0% of the ink was removed by the tape (tape susceptibility of 0%).

### EXAMPLE 9

A correction ink was prepared by adding 9.534 grams of Sancure 815 (a polyurethane resin dispersion in water purchased from Noveon Inc., 9911 Brecksville Road, Cleveland, Ohio) to a 2 oz. wide-mouth HDPE bottle (purchased from Fisher Scientific Co., LLC, 325 Bowles Rd., Agawam, Mass., 01001). Thereafter, 2.113 grams of Ferro 20-8089 glass frit (an unleaded glass enamel flux purchased from Ferro Corporation, 1000 Lakeside Avenue, Cleveland, Ohio, 44114-7000), 0.100 grams of Superpax Zircon Opacifier (a zirconium silicate purchased from Johnson Matthey Ceramics Inc., 498 Acorn Lane, Downington, Pa.), 0.882 grams of Ceramic Flux 94C1001 (an onglaze unleaded flux purchased from Johnson Matthey Ceramics Inc.), 0.05 grams of Cerdec 1795 Black Oxide (a black pigment and silica mixture purchased from Cerdec Corporation/Ferro Corporation, Washington, Pa.) and 3.0 grams of water were added. The wide mouth bottle was then placed in a paint shaker and agitated for eight minutes in order to properly mix the ingredients. When the agitation cycle was completed, 1.00 gram of a 10% solids solution of Solthix A100 (a 30% active polymeric water-based thickener which is described as a hydrophobically modified alkali soluble acrylic emulsion (HMASE) manufactured by The Lubrizol Corporation, 29400 Lakeland Blvd., Wickliffe, Ohio) and 3.32 grams of water were added to the ink. The wide mouthed bottle containing the ink was again placed in the paint shaker and agitated for an additional four minutes in order to mix in the Solthix A100 and thus complete the ink. The finished ink was a thick gel of high viscosity.

A transfer pipette with a 4 millimeter ID nozzle was used to load this correction ink into an empty ¼ oz., 10 millimeter diameter, clear PVC mascara vial (purchased from Drug and Cosmetic Sales Corporation, 1065 S.W. 15^{th} Avenue, Suite 7, Delray Beach, Fla.). The vial was filled to three quarters with correction ink. The cap for the mascara vial, with attached fine brush applicator, was then placed into the mouth of the vial and screwed tight to seal the correction ink in the vial.

The cap of the vial was then unscrewed and the fine brush applicator, saturated with correction ink was then used to fill in twenty of the 1.5 mm square voids on the voided square image fired glass substrate as described in Example 1. The unprinted square areas were covered with correction ink by dabbing the ink saturated brush applicator onto the squares until they were completely filled in with the ink. The correction ink was allowed to dry and the color was shown to be a good match as described in Example 1, as one could not distinguish the touch up ink from the fired image. Chemical susceptibility was tested first by placing two drops of solvent grade toluene onto five of the correction ink treated squares and wiping said solvent off after 30 seconds. It was noted that none of the dry correction ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanol susceptibility). The final chemical susceptibility test was conducted by placing two drops of a generic glass cleaner onto five of the remaining correction inked squares and removing said cleaner after 30 seconds dwell time. The dried correction ink was observed to show no sign of being dissolved during the dwell time and none of the ink was removed with the generic glass cleaner (0% glass cleaner susceptibility). ASTM D3359 classification for the tape susceptibility of this ink after 24 hours was 5 with 0% of this ink was removed by the tape (0% tape susceptibility).

### EXAMPLE 10

The correction ink of this example was prepared by adding 13.938 grams of Sancure 815 to a 2 oz. Fisher wide mouth HDPE bottle. Thereafter, 3.089 grams of Ferro 20-8089 glass frit, 0.146 grams of Superpax Zircon Opacifier, 1.289 grams of Ceramic Flux 94C1001, and 0.073 grams of Cerdec 1795 Black Oxide were added. The wide mouth bottle was then placed in a paint shaker and agitated for eight minutes in order to properly mix the ingredients. When the agitation cycle was completed, 1.463 grams of a 10% solution of Solthix A100 was added to the ink. The wide mouthed bottle containing the ink was again placed in the paint shaker and agitated for an additional four minutes in order to activate the Solthix A100 and thus complete the ink. The finished ink was a thick gel of very high viscosity.

A small metal spatula was used to load the into a 10 millimeter diameter, clear PVC mascara vial as in Example 9.

The cap of the vial was then unscrewed and the fine brush applicator, saturated with correction ink was then used to fill in twenty of the 1.5 mm square voids on the voided square image fired glass substrate as described in Example 1. The unprinted square areas were covered with correction ink by dabbing the ink saturated brush applicator onto the squares until they were completely filled in with the ink. The correction ink was allowed to dry and the color was shown to be a good match as described in Example 9, as one could not distinguish the touch up ink from the fired image. Chemical durability was tested first by placing two drops of solvent grade toluene onto five of the remaining inked squares and wiping said solvent off after 30 seconds. It was noted that none of the ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanol susceptibility). The final chemical durability test was conducted by placing two drops of generic glass cleaner onto five of the remaining inked squares and removing said cleaner after 30 seconds dwell time. The coating was observed to show no sign of being dissolved during the dwell time and none of the ink was removed by the generic glass cleaner (0% glass cleaner susceptibility). ASTM D3359 classification of this ink at 24 hours was 5; 0% of this ink was removed by the tape (0% tape susceptibility).

### EXAMPLE 11

A correction ink was prepared in accordance with the ink prepared in Example 9 except the 0.05 grams of Cerdec 1795 Black Oxide was replaced with 0.05 grams of Cerdec 9025 Blue (a blue pigment and silica mixture purchased from Cerdec Corporation/Ferro Corporation, Washington, Pa.)

A transfer pipette with a 4 millimeter ID nozzle was used to load this correction ink into a 10 millimeter diameter, clear PVC mascara vial as in Example 9.

The cap of the vial was then unscrewed and the fine brush applicator, saturated with correction ink was then used to fill in twenty of the 1.5 mm square voids on the voided square image fired glass substrate as described in Example 1. The unprinted square areas were covered with correction ink by dabbing the ink saturated brush applicator onto the squares until they were completely filled in with the ink. The correction ink was allowed to dry and the color was shown to be a good match as described in Example 9, as one could not distinguish the touch up ink from the fired image. Chemical durability was tested first by placing two drops of solvent grade toluene onto five of the remaining inked squares and wiping said solvent off after 30 seconds. It was noted that none of the ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanol susceptibility). The final chemical durability test was conducted by placing two drops of generic glass cleaner onto the five of the remaining inked squares and removing said cleaner after 30 seconds dwell time. The coating was observed to show no sign of being dissolved during the dwell time and none of the ink was removed with the generic glass cleaner (0% glass cleaner susceptibility). ASTM D3359 classification of this ink at 24 hours was 5; 0% of the ink was removed by the tape (0% tape susceptibility).

### EXAMPLE 12

A correction ink was prepared in accordance with the procedure outlined in Example 9 except the 0.05 grams of Cerdec 1795 Black Oxide was replaced with 0.05 grams of Cerdec 9625 Maroon (a maroon pigment and silica mixture purchased from Cerdec Corporation/Ferro Corporation, Washington, Pa.)

A transfer pipette with a 4 millimeter ID nozzle was used to load this correction ink into a 10 millimeter diameter, clear PVC mascara vial as in Example 9.

The cap of the vial was then unscrewed and the fine brush applicator, saturated with correction ink was then used to fill in twenty of the 1.5 mm square voids on the voided square image fired glass substrate as described in Example 1. The unprinted square areas were covered with correction ink by dabbing the ink saturated brush applicator onto the squares until they were completely filled in with the ink. The correction ink was allowed to dry and the color was shown to be a good match as described in Example 9, as one could not distinguish the touch up ink from the fired image. Chemical durability was tested first by placing two drops of solvent grade toluene onto five of the remaining inked squares and wiping said solvent off after 30 seconds. It was noted that none of the ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanol susceptibility). The final chemical durability test was conducted by placing two drops of generic glass cleaner onto five of the remaining inked squares and removing said cleaner after 30 seconds dwell time. The coating was observed to show no sign of being dissolved during the dwell time and none of the ink was removed with the generic glass cleaner (0% glass cleaner susceptibility). ASTM D3359 classification of this ink at 24 hours was 5; 0% of the ink was removed by the tape (0% tape susceptibility).

### EXAMPLE 13

A correction ink was prepared by adding 9.534 grams of Sancure 815 to a 2 oz. Fisher wide mouth HDPE bottle. Thereafter, 2.325 grams of Ferro 20-8380 glass frit, 0.453 grams of Superpax Zircon Opacifier, 0.389 grams of Ceramic Flux 94C1001, 0.20 grams of RCL-3 (a dry rutile titanium dioxide pigment purchased from SCM Chemicals, 7 St. Paul St., Suite 1010, Baltimore, Md.) and 3.0 grams of water were added. The wide mouth bottle was then placed in a paint shaker and agitated for eight minutes in order to properly mix the ingredients. When the agitation cycle was completed, 1.00 gram of a 10% solution of Solthix and 3.32 grams of water were added to the ink. The wide mouthed bottle containing the ink was again placed in the paint shaker and agitated for an additional four minutes in order to activate the Solthix A100 and thus complete the ink. The finished ink was a thick gel of high viscosity.

A transfer pipette with a 4 millimeter ID nozzle was used to load this correction ink into a 10 millimeter diameter, clear PVC mascara vial as in Example 9.

The cap of the vial was then unscrewed and the fine brush applicator, saturated with correction ink was then used to fill in twenty of the 1.5 mm square voids on the voided square image fired glass substrate as described in Example 1. The unprinted square areas were covered with correction ink by dabbing the ink saturated brush applicator onto the squares until they were completely filled in with the ink. The correction ink was allowed to dry and the color was shown to be a good match as described in Example 9, as one could not distinguish the touch up ink from the fired image. Chemical durability was tested first by placing two drops of solvent grade toluene onto five of the remaining inked squares and wiping said solvent off after 30 seconds. It was noted that none of the ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanol susceptibility). The final chemical durability test was conducted by placing two drops of generic glass cleaner onto five of the remaining inked squares and removing said cleaner after 30 seconds dwell time. The coating was observed to show no sign of being dissolved during the dwell time and none of the ink was removed with the generic glass cleaner (0% glass cleaner susceptibility). ASTM D3359 classification of this ink at 24 hours was 5; 0% of the ink was removed by the tape (0% tape susceptibility).

### EXAMPLE 14

The correction ink prepared in Example 9 was used in this example.

A transfer pipette with a 4 millimeter ID nozzle was used to load this correction ink into a 10 millimeter diameter, clear PVC mascara vial as in Example 9.

An unfired glass substrate with the adhesively attached, voided square image printed, covercoat was prepared as described in Example 1.

The cap of the vial was then unscrewed and the fine brush applicator, saturated with correction ink was then used to fill in twenty of the 1.5 mm square voids on the voided square image adhesively attached to an un-fired glass substrate. The patches were made by dabbing the ink saturated brush applicator of the mascara vial onto the substrate, thus transferring the ink onto the raw glass. The correction ink patched glass substrate was then fired in a kiln at 680° C. for 2 minutes and 20 seconds, thus bonding the frit containing patches as well as the voided square ceramic frit image to the glass substrate, making them permanent.

Chemical durability was tested first by placing two drops of solvent grade toluene onto five of the remaining inked squares and wiping said solvent off after 30 seconds. It was noted that none of the ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanol susceptibility). The final chemical durability test was conducted by placing two drops of generic glass cleaner onto five of the remaining inked squares and removing said cleaner after 30 seconds dwell time. The coating was observed to show no sign of being dissolved during the dwell time and none of the ink was removed with the generic glass cleaner (0% glass cleaner susceptibility). ASTM D3359 classification of this ink at 24 hours was 5; 0% of the ink was removed by the tape (0% tape susceptibility).

### EXAMPLE 15

The correction ink prepared in Example 9 was used in this example.

A transfer pipette with a 4 millimeter ID nozzle was used to load this correction ink into a 10 millimeter diameter, clear PVC mascara vial as in Example 9.

A transfer decal sheet consisting of a paper backing sheet, a releasable covercoat digitally printed with the voided square image was prepared as in Example 1. The cap of the vial was then unscrewed and the fine brush applicator, saturated with correction ink was then used to fill in twenty of the 1.5 mm square voids on the voided square image of the transfer decal sheet. The square voids were patched by dabbing the ink saturated brush applicator of the mascara vial onto the voids, thus transferring the ink onto the decal, until they were completely filled in with the ink. The image decal, including the square voids filled with the dried correction ink of this example was then transferred off the transfer decal sheet and onto a 10 cm square piece of 6 mm thick float glass using a thin (3.5 micron thick), unsupported acrylic transfer adhesive type U733-1 (purchased from Scapa North America Inc., 111 Great Pond Drive, Windsor, Conn. 06095). In the first step of this process one of the two release liners of the transfer adhesive was peeled away to expose the adhesive layer. The 10 cm square glass substrate was then placed on the exposed adhesive. A squeegee was pulled across the back side of the transfer adhesive sheet by hand to remove air bubbles and to ensure intimate contact between the adhesive and glass substrate. Next, the second release was removed from the transfer adhesive, leaving the adhesive on the glass substrate. The transfer decal sheet, with dried squares of correction ink, was placed image side down onto the adhesive laminated glass. The paper backing of the transfer decal sheet was then peeled from the glass substrate and adhesive, leaving the covercoat, frit image and correction ink squares on the glass substrate. The imaged glass substrate was then fired in a kiln at 680° C. for 2 minutes and 20 seconds, thus bonding the printed image and correction ink patches to the glass substrate and removing most of the organic compounds. The fired correction ink patches were judged to be a good color match to the fired frit ink patches after firing using the procedure described in Example 1.

Chemical durability was tested first by placing two drops of solvent grade toluene onto five of the remaining inked squares and wiping said solvent off after 30 seconds. It was noted that none of the ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanol susceptibility). The final chemical durability test was conducted by placing two drops of generic glass cleaner onto five of the remaining inked squares and removing said cleaner after 30 seconds dwell time. The coating was observed to show no sign of being dissolved during the dwell time and none of the ink was removed with the generic glass cleaner (0% glass cleaner susceptibility).

### EXAMPLE 16

A correction ink was prepared by adding 9.534 grams of Sancure 815 to a 2 oz. Fisher wide mouth HDPE bottle. Thereafter, 2.113 grams of Ferro 20-8089 glass frit, 0.100 grams of Superpax Zircon Opacifier, 0.619 grams of Ceramic Flux 94C1001, 0.050 grams of Cerdec 9625 Maroon, 0.470 grams of Aquamat 270 (a modified polyethylene wax dispersion purchased from BYK-Chemie USA Inc, 524 South Cherry Street, Wallingford, Conn.) and 3.0 grams of water were added. The wide mouth bottle was then placed in a paint shaker and agitated for eight minutes in order to properly mix the ingredients. When the agitation cycle was completed, 1.00 gram of a 10% solution of Solthix A100 and 3.32 grams of water were added to the ink. The wide mouthed bottle containing the ink was again placed in the paint shaker and agitated for an additional four minutes in order to activate the Solthix A100 and thus complete the ink. The finished ink was a thick gel of high viscosity.

A transfer pipette with a 4 millimeter ID nozzle was used to load this correction ink into a 10 millimeter diameter, clear PVC mascara vial as in Example 9.

The cap of the vial was then unscrewed and the fine brush applicator, saturated with correction ink was then used to fill in twenty of the 1.5 mm square voids on the voided square image fired glass substrate as described in Example 1. The unprinted square areas were covered with correction ink by dabbing the ink saturated brush applicator onto the squares until they were completely filled in with the ink. After a 24 hour period of cure time, the patches produced in this example were evaluated for chemical durability by placing two drops of solvent grade toluene onto five of the remaining inked squares and wiping said solvent off after 30 seconds. It was noted that none of the ink in this example was removed from the glass when the solvent was wiped off (0% toluene susceptibility). The next five of the remaining inked squares were treated with two drops of solvent grade 2-propanol. This was allowed 30 seconds of dwell time, after which the solvent was wiped off. It was observed that the coating was totally removed by this solvent (100% 2-propanol susceptibility). The final chemical durability test was conducted by placing two drops of generic glass cleaner onto five of the remaining inked squares and removing said cleaner after 30 seconds dwell time. The coating was observed to show no sign of being dissolved during the dwell time but all of the ink was removed with the generic glass cleaner (100% glass cleaner susceptibility). ASTM D3359 classification for this ink at 24 hours was 4; less than 5% of the ink was removed by the tape (<5% tape susceptibility)

### EXAMPLE 17

The white thermal transfer ink of Comparative Example 1 described in U.S. Pat. No. 6,706,341 was prepared. This ink was comprised of about 67 dry weight percent of 0.35 micron particle size rutile titanium dioxide particles and about 32 dry weight percent of a mixture of acrylic and polyester thermoplastic binders.

A transfer pipette with a 4 millimeter ID nozzle was used to load this correction ink into a 10 millimeter diameter, clear PVC mascara vial as in Example 9.

The cap of the vial was then unscrewed and the fine brush applicator, saturated with correction ink was then used to fill in twenty of the 1.5 mm square voids on the voided square image fired glass substrate as described in Example 1. The correction ink was allowed to dry and the color was shown to be a good match as described in Example 9, as one could not distinguish the touch up ink from the fired image. After a one hour period of cure time, the patches produced in this example were evaluated for chemical durability by placing two drops of solvent grade toluene onto five of the remaining inked squares and wiping said solvent off after 30 seconds. It was noted that all of the ink in this example was removed from the glass when the solvent was wiped off (100% toluene susceptibility). The next five of the remaining inked squares were treated with two drops of solvent grade 2-propanol. This was allowed 30 seconds of dwell time, after which the solvent was wiped off. It was observed that the coating was unaffected by this solvent (0% 2-propanal susceptibility). The final chemical durability test was conducted by placing two drops of generic glass cleaner onto five of the remaining inked squares and removing said cleaner after 30 seconds dwell time. The coating was observed to show no sign of being dissolved during the dwell time but about three percent of the ink was removed with the generic glass cleaner (3% glass cleaner susceptibility). ASTM D3359 classification for this ink at 24 hours was 1; about 45% of the ink was removed by the tape (45% tape susceptibility).

### EXAMPLE 18

The correction ink of Example 9 was used in this example.

A transfer pipette with a 4 millimeter ID nozzle was used to load this correction ink into a 10 millimeter diameter, clear PVC mascara vial as in Example 9.

A voided square image was digitally printed with a ceramic frit ribbon as described in Example 1 except that a piece of Wincos A261 RC film (a 2 mil. Clear window film with clear permanent adhesive purchased from Lintec of America, Inc., 1292 Barclay Blvd., Buffalo Grove, Ill.) that was printed rather than a transfer decal sheet.

The brush of the mascara vial was used to fill in several unprinted voids on the Wincos film by dabbing the ink saturated brush applicator of the mascara vial onto the voids, thus transferring the ink onto the raw printed substrate, until they were completely filled in with the ink. The correction ink was allowed to dry and the color was shown to be a good match as described in Example 9, as one could not distinguish the touch up ink from the fired image.

### EXAMPLE 19

A correction ink was prepared in accordance with the ink prepared in Example 9 except the 1.00 gram of a 10% solids solution of Solthix A100 rheology modifier was replaced with 0.196 g of BYK-425 (a 52% solids rheology modifier in N-methylpyrrolidone supplied by Dar-Tech, Inc., 16485 Rockside Rd., Cleveland, Ohio 44137-4336) and 0.196 g of BYK-420 (a 52% solids rheology modifier in polypropylene glycol 600 supplied by Dar-Tech, Inc., 16485 Rockside Rd., Cleveland, Ohio 44137-4336) and no additional water was required to achieve an acceptable ink rheology.

This correction ink was tested in accordance with ASTM D3359 classification for the tape susceptibility described above. The tape susceptibility of this ink after 2 hours was 5 with 0% of this ink was removed by the tape (0% tape susceptibility).

### EXAMPLE 20

A correction ink was prepared in accordance with the ink prepared in Example 19 except the 13.938 grams of Sancure 815 was reduced to 5.53 grams to lower the concentration of binder relative to binder and particles.

This correction ink was tested in accordance with ASTM D3359 classification for the tape susceptibility described above. The tape susceptibility of this ink after 2 hours was 4 with 10% of this ink was removed by the tape (10% tape susceptibility).

### EXAMPLE 21

A correction ink was prepared in accordance with the ink prepared in Example 19 except the 13.938 grams of Sancure 815 was reduced to 2.75 grams to futher lower the concentration of binder relative to binder and particles.

This correction ink was tested in accordance with ASTM D3359 classification for the tape susceptibility described above. The tape susceptibility of this ink after 2 hours was 0 with more than 65% of this ink was removed by the tape (>65% tape susceptibility).

### EXAMPLE 22

A correction ink was prepared in accordance with the ink prepared in Example 20 except the 13.938 grams of Sancure 815 was reduced to 1.37 grams to futher lower the concentration of binder relative to binder and particles.

This correction ink was tested in accordance with ASTM D3359 classification for the tape susceptibility described above. The tape susceptibility of this ink after 2 hours was 0 with more than 65% of this ink was removed by the tape (>65% tape susceptibility).

It is therefore, apparent that there has been provided, in accordance with the present invention, a method and apparatus for correcting image defects in ceramic substrates. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A ceramic correction fluid comprising:
a thermoplastic binder;
particles selected from the group consisting of translucent particles, opaque particles, transparent particles, and combinations thereof; and
a liquid medium; wherein
said thermoplastic binder is present at a concentration of from about 15 percent to about 90 percent by weight of said thermoplastic binder and said particles;
said particles are present at a concentration of at least about 10 percent by weight of said thermoplastic binder and said particles; and
when said ceramic correction fluid is applied to a glass substrate and allowed to stand for about twenty four hours at a temperature of about 22 degrees Celsius, said ceramic correction fluid has a tape susceptibility of less than about 15 percent.

2. The ceramic correction fluid as recited in claim 1, wherein, when said ceramic correction fluid is applied to a glass substrate and allowed to stand for about twenty four hours at a temperature of about 22 degrees Celsius, said ceramic correction fluid has a glass cleaner susceptibility of less than about 5 percent.

3. The ceramic correction fluid as recited in claim 2, wherein, when said ceramic correction fluid is applied to a glass substrate and allowed to stand for about twenty four hours at a temperature of about 22 degrees Celsius, said ceramic correction fluid has a 2-propanol susceptibility of less than about 5 percent.

4. The ceramic correction fluid as recited in claim 3, wherein, when said ceramic correction fluid is applied to a glass substrate and allowed to stand for about twenty four hours at a temperature of about 22 degrees Celsius, said ceramic correction fluid has a toluene susceptibility of less than about 5 percent.

5. The ceramic correction fluid as recited in claim 1, wherein said translucent particles are glass frit particles.

6. The ceramic correction fluid as recited in claim 5, wherein said glass frit particles have a size in the range of about 0.1 microns to about 20 microns.

7. The ceramic correction fluid as recited in claim 6, wherein said glass frit particles have a size in the range of about 0.1 microns to about 10 microns.

8. The ceramic correction fluid as recited in claim 5, wherein said thermoplastic binder is present at a concentration of from about 30 percent to about 80 percent by weight of said thermoplastic binder and said glass frit.

9. The ceramic correction fluid as recited in claim 8, wherein said thermoplastic binder is a resin selected from the group consisting of a polyester resin, a bisphenol-A polyester, a polyvinyl chloride, a copolymer made from terephthalic acid, a polymethylmethacrylate, a vinylchloride/vinylacetate resins, an epoxy resin, a nylon resin, a urethane-formaldehyde resin, a polyurethane, a styrene/acrylate copolymer, a styrene/butadiene copolymer and combinations thereof.

10. The ceramic correction fluid as recited in claim 8, wherein said thermoplastic binder is comprised of a polyurethane resin.

11. The ceramic correction fluid as recited in claim 10, further comprising a second thermoplastic binder selected from the group consisting of a polyester resin, a bisphenol-A polyester, a polyvinyl chloride, a copolymer made from terephthalic acid, a polymethylmethacrylate, a vinylchloride/vinylacetate resin, an epoxy resin, a nylon resin, a urethane-formaldehyde resin, a polyurethane, a styrene/acrylate copolymer, a styrene/butadiene copolymer and combinations thereof.

12. The ceramic correction fluid as recited in claim 8, wherein said thermoplastic binder is an ultraviolet curable thermoplastic binder.

13. The ceramic correction fluid as recited in claim 1, further comprising an opacification agent.

14. The ceramic correction fluid as recited in claim 13, wherein said translucent particles are glass frit particles and said glass frit particles have a melting point that is at least 50 degrees Celsius lower than the melting point of said opacification agent.

15. The ceramic correction fluid as recited in claim 14, wherein said glass frit particles have a melting point that is at least 100 degrees Celsius lower than the melting point of said opacificaiton agent.

16. The ceramic correction fluid as recited in claim 1, wherein said particles are present at a concentration of from about 15 percent to about 85 percent by weight of said thermoplastic binder and said particles.

17. The ceramic correction fluid as recited in claim 16, wherein said particles are present at a concentration of from about 25 percent to about 75 percent by weight of said thermoplastic binder and said particles.

18. The ceramic correction fluid as recited in claim 1, further comprising a rheology modifier.

19. A ceramic correction assembly comprising a ceramic correction fluid applicator and a ceramic correction fluid comprising;
a thermoplastic binder;
particles selected from the group consisting of translucent particles, opaque particles, transparent particles, and combinations thereof; and
a liquid medium; wherein said thermoplastic binder is present at a concentration of from about 15 percent to about 90 percent by weight of said thermoplastic binder and said particles;
said particles are present at a concentration of at least about 10 percent by weight of said thermoplastic binder and said particles; and
when said ceramic correction fluid is applied to a glass substrate and allowed to stand for about twenty four hours at a temperature of about 22 degrees Celsius, said ceramic correction fluid has a tape susceptibility of less than about 15 percent.

20. The ceramic correction assembly as recited in claim 19, wherein said ceramic correction fluid applicator is a thermal transfer ribbon and said ceramic correction fluid is disposed on said ceramic correction fluid applicator.

21. The ceramic correction assembly as recited in claim 19, wherein said ceramic correction fluid applicator is a pen and said ceramic correction fluid is disposed in said pen.

22. The ceramic correction assembly as recited in claim 19, wherein said ceramic correction fluid applicator is a brush and said ceramic correction fluid is disposed on said brush.

23. The ceramic correction assembly as recited in claim 22, further comprising a vial wherein said ceramic correction fluid is disposed within said vial and wherein said brush is operatively configured to securely fit into said vial.

24. A corrected ceramic substrate comprising:
a substrate;
an image disposed on said substrate, wherein said image is comprised of imaged portions and void portions; and wherein
said void portions have been patched with a ceramic correction fluid comprised of;
a thermoplastic binder;
particles selected from the group consisting of translucent particles, opaque particles, transparent particles, and combinations thereof; and
a liquid medium; wherein
said thermoplastic binder is present at a concentration of from about 15 percent to about 90 percent by weight of said thermoplastic binder and said particles;
said particles are present at a concentration of at least about 10 percent by weight of said thermoplastic binder and said particles; and
when said ceramic correction fluid is applied to said substrate and allowed to stand for about twenty four hours at a temperature of about 22 degrees Celsius, said ceramic correction fluid has a tape susceptibility of less than about 6 percent.

25. The corrected ceramic substrate as recited in claim 24, wherein said thermoplastic binder is comprised of a polyurethane resin.

26. The corrected ceramic substrate as recited in claim 24, wherein, when said ceramic correction fluid is applied to said substrate and allowed to stand for about twenty four hours at a temperature of about 22 degrees Celsius, said ceramic correction fluid has a glass cleaner susceptibility of less than about 2 percent.

27. The corrected ceramic substrate as recited in claim 26, wherein said substrate is selected from the group consisting of a glass substrate, a ceramic substrate, and combinations thereof;

28. The corrected ceramic substrate as recited in claim 26, wherein said substrate is a floating glass substrate.

29. The corrected ceramic substrate as recited in claim 27, wherein said substrate is further comprised of metal oxides.

30. The corrected ceramic substrate as recited in claim 29, wherein said substrate is a ceramic substrate selected from the group consisting of a ceramic whiteware, an enamel, a porcelain, and combinations thereof.

31. The corrected ceramic substrate as recited in claim 26, wherein said substrate is a plastic film.

32. The corrected ceramic substrate as recited in claim 26, wherein said substrate is a window film.

33. The corrected ceramic substrate as recited in claim 26, wherein said substrate is a silicon wafer.

34. The corrected ceramic substrate as recited in claim 26, wherein said substrate is tempered glass.

35. The corrected ceramic substrate as recited in claim 26, wherein said substrate is reflective glass.

36. The corrected ceramic substrate as recited in claim 26, wherein said imaged portions are comprised of glass frit.

37. The corrected ceramic substrate as recited in claim 36, wherein said imaged portions are further comprised of an opacification agent.

38. The corrected ceramic substrate as recited in claim 36, wherein said imaged portions are further comprised of pigments.

39. The corrected ceramic substrate as recited in claim 26, wherein said ceramic correction fluid is further comprised of from about 0.1 to about 66 weight percent of an opacification agent.

40. The corrected ceramic substrate as recited in claim 39, wherein said opacification agent is present at a concentration of from about 0.1 to about 25 weight percent.

41. The corrected ceramic substrate as recited in claim 40, wherein said ceramic correction fluid is further comprised of a first colorant at a concentration of from about 0.1 to about 34 weight percent.

42. The corrected ceramic substrate as recited in claim 41, wherein said first colorant is an organic pigment.

43. The corrected ceramic substrate as recited in claim 41, wherein said first colorant is an inorganic colorant.

44. The corrected ceramic substrate as recited in claim 42, wherein said inorganic colorant is a metal-oxide.

45. The corrected ceramic substrate as recited in claim 41, wherein said ceramic correction fluid is further comprised of a second colorant, wherein said second colorant has a different color than said first colorant.

46. The corrected ceramic substrate as recited in claim 26, said imaged portions and said void portions are matched such that they have a Delta-E value of less than about 10.

47. The corrected ceramic substrate as recited in claim 26, said imaged portions and said void portions are matched such that they have a Delta-E value of less than about 5.

48. The corrected ceramic substrate as recited in claim 26, said imaged portions and said void portions are matched such that they have a Delta-E value of less than about 3.

49. The corrected ceramic substrate as recited in claim 24, wherein said tape susceptibility is about 0 percent.

50. The corrected ceramic substrate as recited in claim 24, wherein said glass cleaner susceptibility is about 0 percent.
